(19) United States
(12) Patent Application Publication
(10) Pub. No.: US 2004/0117427 A1
(43) Pub. Date: Jun. 17, 2004

(54) System and method for distributing streaming media

(75) Inventors: Geoff Allen, Sterling, VA (US); Timothy Ramsey, Chantilly, VA (US); Steve Geyer, Herndon, VA (US); Alan Gardner, Potomac, MD (US); Rod McElrath, Fairfax, VA (US)

Correspondence Address: Ronald Abramson, Hughes Hubbard & Reed LLP, One Battery Park Plaza, New York, NY, 10004-1482, US

(73) Assignee: Anystream, Inc., Sterling, VA

(21) Appl. No.: 10/661,264

(22) Filed: Sep. 12, 2003

Related U.S. Application Data
(63) Continuation of application No. PCT/US02/06637, filed on Mar. 15, 2002.
(60) Provisional application No. 60/276,756, filed on Mar. 16, 2001.
(60) Provisional application No. 60/297,563, filed on Jun. 12, 2001.
(60) Provisional application No. 60/297,655, filed on Jun. 12, 2001.

(51) Int. Cl. G06F 15/16

(52) U.S. Cl. 709/200

(57) ABSTRACT

A high-performance, adaptive and scalable system for distributing streaming media, in which processing into a plurality of output formats is controlled in a real-time distributed manner, and which further incorporates processing improvements relating to workflow management, video acquisition and video preprocessing. The processing system may be used as part of a high-speed content delivery system in which such streaming media processing is conducted at the edge of the network, allowing video producers to supply improved live streaming experience to multiple simultaneous users independent of the users' individual viewing device, network connectivity, bit rate and supported streaming formats. Methods by which such system may be used to commercial advantage are also described.

### CROSS-REFERENCE TO RELATED APPLICATIONS

This is a continuation of International Application PCT/US02/06637, with an international filing date of Mar. 15, 2002, published in English under Article 21(2), which in turn claims the benefit of the following U.S. provisional patent application serial Nos. 60/276,756 (filed Mar. 16, 2001), 60/297,563 and 60/297,655 (both filed Jun. 12, 2001), and also claims benefit of U.S. nonprovisional patent application Ser. No. 10/076,872, entitled “A GPI Trigger Over TCP/IP for Video Acquisition,” filed Feb. 12, 2002. All of the above-mentioned applications, commonly owned with the present application, are hereby incorporated by reference herein in their entirety.

### BACKGROUND OF THE INVENTION

1. Field of the Invention

The present invention relates to the fields of computer operating systems and process control, and more particularly to techniques for command and control of a distributed process system. The present invention also relates to the fields of digital signal processing, and more particularly to techniques for the high-performance digital processing of video signals for use with a variety of streaming media encoders. This invention further relates to the field of distribution of streaming media. In particular, the invention allows content producers to produce streaming media in a flexible and scalable manner, and preferably to supply the streaming media to multiple simultaneous users through a local facility, in a manner that tailors the delivery stream to the capabilities of the user's system, and provides a means for the local distributor to participate in processing and adding to the content.

2. Description of the Related Art

As used in this specification and in the claims, “Streaming media” means distribution media by which data representing video, audio and other communication forms, both passively viewable and interactive, can be processed as a steady and continuous stream. Also relevant to certain embodiments described herein is the term “edge,” which is defined as a location on a network within a few network “hops” to the user (as the word “hop” is used in connection with the “traceroute” program), and most preferably (but not necessarily), a location within a single network connection hop from the end user. The “edge” facility could be the local point-of-presence (PoP) for modem and DSL users, or the cable head end for cable modem users. Also used herein is the term “localization,” which is the ability to add local relevance to content before it reaches end users. This includes practices like local advertising insertion or watermarking, which are driven by demographic or other profile-driven information.

Streaming media was developed for transmission of video and audio over networks such as the Internet, as an alternative to having to download an entire file representing the subject performance, before the performance could be viewed. Streaming technology developed as a means to “stream” existing media files on a computer, in, for example, “.avi” format, as might be produced by a video capture device.

A great many systems of practical significance involve distributed processes. One aspect of the present invention concerns a scheme for command and control of such distributed processes. It is important to recognize that the principles of the present invention have extremely broad potential application. An example of a distributed process is the process of preparing streaming media for mass distribution to a large audience of users based on a media feed, for example a live analog video feed. However, this is but one example of a distributed processing system, and any number of other examples far removed from media production and distribution would serve equally well for purposes of illustration. For example, a distributed process for indexing a large collection of digital content could be used as a basis for explanation, and would fully illustrate the same fundamental principles about to be described herein in the context of managing a distributed process for producing and distributing streaming media.

One prior art methodology for preparing streaming video media for distribution based on a live feed is illustrated in FIG. 1A. Video might be acquired, for example, at a camera (102). The video is then processed in a conventional processor, such as a Media 100® or Avid OMF® (104). The output of such a processor is very high quality digital media. However, the format may be incompatible with the format required by many streaming encoders. Therefore, as a preliminary step to encoding, the digital video must (in the case of such incompatibility) be converted to analog in D-A converter (106), and then redigitized into .avi or other appropriate digital format in A-D converter (108). The redigitized video is then simultaneously processed in a plurality of encoders (110-118), which each provide output in a particular popular format and bit rate. (In a video on demand environment, the encoding would occur at the time requested, or the content could be pre-stored in a variety of formats and bit rates.) Alternately, as shown in FIG. 1B, the analog video from 106 may be routed to a distribution amplifier 107, which creates multiple analog distribution streams going to separate encoder systems (110-118), each with its own capture card (or another intermediary computer) (108A-108E) for A to D conversion.

To serve multiple users with varying format requirements, therefore, requires the typical prior art system to simultaneously transmit a plurality of signals in different formats simultaneously. A limited menu, corresponding to the encoders (110-118) available, is presented to the end user (124). The end user is asked to make a manual input (click button, check box, etc.) to indicate to Web server (120), with which user (124) has made a connection over the Internet (122), the desired format (Real Media, Microsoft Media, Quicktime, etc.), as well as the desired delivery bit rate (e.g., 28.8K, 56K, 1.5M, etc.). The transmission system then serves the format and speed so selected.

The problems with the prior art approach are many, and include:

None of the available selections may match the end users' particular requirements.

Converting from digital to analog, and then back to digital, degrades signal quality.

Simultaneous transmission in different formats needlessly consumes network bandwidth.

There is no ability to localize either formats or content, i.e., to tailor the signal to a particularized local market.

There is no means, after initial system setup, to reallocate resources among the various encoders.

Conventional video processing equipment does not lend itself to automated adaptation of processing attributes to the characteristics of the content being processed.

Single point failure of an encoder results in complete loss of an output format.

Because of bandwidth requirements and complexity, the prior art approach cannot be readily scaled.

Because Internet streaming media users view the stream using a variety of devices, formats and bit rates, it is highly probable that the user will have a sub-optimal experience using currently existing systems.

The video producer, in an effort to make the best of this situation, chooses a few common formats and bit rates, but not necessarily those optimal for a particular viewer. These existing solutions require the video producer to encode the content into multiple streaming formats and attempt to have a streaming format and bit rate that matches the end user. The user selects the format closest to their capability, or goes without if their particular capability is not supported. These solutions also require the producers to stream multiple formats and bit rates, thereby consuming more network bandwidth.

Similar problems beset other distributed processing situations in which resources may be statically allocated, or at least not allocated in a manner that is responsive in real time to actual processing requirements.

In the area of video processing, considerable technology has developed for capturing analog video, for example, from a video camera or videotape, and then digitizing and encoding the video signal for streaming distribution over the Internet.

A number of encoders are commercially available for this purpose, including encoders for streaming media in, for example, Microsoft® Media, Real® Media, or Quicktimeg formats. A given encoder typically contains facilities for converting the video signal so as to meet the encoder's own particular requirements.

Alternatively, the video stream can be processed using conventional video processing equipment prior to being input into the various encoders.

However, source video typically comes in a variety of standard formats, and the available encoders have different characteristics insofar as their own handling of video information is concerned. Generally, the source video does not have characteristics that are well-matched for presentation to the encoders.

The problems with the prior art approaches include the following:

(a) Streaming encoders do not supply the processing options required to create a video stream with characteristics well-tailored for the viewer. The video producer may favor different processing options depending on the nature of the video content and the anticipated video compression. As an example, the producer of a romantic drama may favor the use of temporal smoothing to blur motion, resulting in a video stream with a fluid appearance that is highly compressible in the encoding. With a different source, such as a sporting event, the producer may favor processing that discards some of the video information but places very sharp “stop-action” images into each encoded frame. The streaming encoder alone is unable to provide these different image-processing choices. Furthermore, the producer needs to use a variety of streaming encoders to match those in use by the end-user, but each encoder has a different set of image processing capabilities. The producer would like to tailor the processing to the source material, but is unable to provide this processing consistently across all the encoders.

(b) Currently available tools for video processing do not provide all the required image processing capability in an efficient method that is well-suited for real-time conversion and integration with an enterprise video production workflow.

To date, few investigators have had reason to address the problem of controlling image quality across several streaming video encoding applications. Those familiar with streaming video issues are often untrained in signal or image processing. Image processing experts are often unfamiliar with the requirements and constraints associated with streaming video for the Internet. However, the foregoing problems have become increasingly significant with increased requirements for supported streaming formats, and the desire to be able to process a large volume of video materially quickly, in some cases in real time. As a result, it has become highly desirable to have processing versatility and throughput performance that is superior to that which has been available under prior art approaches.

In the area of streaming media, existing methods of processing and encoding streaming media for distribution, as well as the architecture of current systems for delivering streaming media content, have substantial limitations.

Limitations of Current Processing and Encoding Technology

Internet streaming media users view the streams that they receive using a variety of devices, formats and bit rates. In order to operate a conventional streaming encoder, it is necessary to specify, before encoding, the output format (e.g., Real® Media, Microsoft® Media, Quicktime®, etc.), as well as the output bit rate (e.g., 28.8K, 56K, 1.5M, etc.).

In addition to simple streaming encoding and distribution, many content providers also wish to perform some video preprocessing prior to encoding. Some of the elements of such preprocessing include format conversion from one video format (e.g., NTSC, YUV, etc.) to another, cropping, horizontal scaling, sampling, deinterlacing, filtering, temporal smoothing, filtering, color correction, etc. In typical prior art systems, these attributes are adjusted through manual settings by an operator.

Currently, streaming encoders do not supply all of the processing options required to create a stream with characteristics that are optimal for the viewer. For example, a video producer may favor different processing options depending on the nature of the video content and the anticipated video compression. Thus, the producer of a romantic drama may favor the use of temporal smoothing to blur motion, resulting in a video stream with a fluid appearance that is highly compressible in the encoding. With a different source, such as a sporting event, the producer may favor processing that discards some of the video information but places very sharp “stop-action” images into each encoded frame. The streaming encoder alone is unable to provide these different image-processing choices. Furthermore, the producer needs to use a variety of streaming encoders to match those in use by the end-user, but each encoder has a different set of image processing capabilities. The producer would like to tailor the processing to the source material, but is unable to provide this processing consistently across all the encoders.

Equipment, such as the Media 100D exists to partially automate this process.

Currently available tools for video processing, such as the Media 100, do not provide all the required image processing capability in an efficient method that is well-suited for real-time conversion and integration with an enterprise video production workflow. In some cases, the entire process is essentially bypassed, going from a capture device directly into a streaming encoder.

In practice, a sophisticated prior art encoding operation, including some video processing capability, might be set up as shown in FIG. 1A. Video might be acquired, for example, at a camera (102). The video is then processed in a conventional processor, such as a Media 100® or Avid OMF® (104). The output of such a processor is very high quality digital media. However, the format may be incompatible with the format required by many streaming encoders. Therefore, as a preliminary step to encoding, the digital video must be converted to analog in D-A converter (106), and then redigitized into .avi or other appropriate digital format in A-D converter (108). The redigitized video is then simultaneously processed in a plurality of encoders (110-118), which each provide output in a particular popular format and bit rate (in a video on demand environment, the encoding would occur at the time requested, or the content could be pre-stored in a variety of formats and bit rates). To serve multiple users with varying format requirements, therefore, requires the typical prior art system to simultaneously transmit a plurality of signals in different formats. A limited menu, corresponding to the encoders (110-118) available, is presented to the end user (124). The end user is asked to make a manual input (click button, check box, etc.) to indicate to Web server (120), with which user (124) has made a connection over the Internet (122), the desired format (Real Media, Microsoft Media, Quicktime, etc.), as well as the desired delivery bit rate (e.g., 28.8K, 56K, 1.5M, etc.). The transmission system then serves the format and speed so selected.

The problems with the prior art approach are many, and include:

None of the available selections may match the end users' particular requirements.

Converting from digital to analog, and then back to digital, degrades signal quality.

Simultaneous transmission in different formats needlessly consumes network bandwidth.

There is no ability to localize either formats or content, i.e, to tailor the signal to a particularized local market.

There is no means, after initial system setup, to reallocate resources among the various encoders.

Conventional video processing equipment does not lend itself to automated adaptation of processing attributes to the characteristics of the content being processed.

Single point failure of an encoder results in complete loss of an output format.

Because of bandwidth requirements and complexity, the prior art approach cannot be readily scaled.

Limitations ofPrior Art Delivery Systems

Because Internet streaming media users view the stream using a variety of devices, formats and bit rates, it is highly probable that the user will have a sub-optimal experience using currently existing systems. This is a result of the client-server architecture used by current streaming media solutions which is modeled after the client-server technology that underpins most networking services such as web services and file transfer services. The success of the client-server technology for these services causes streaming vendors to emulate client-server architectures, with the result that the content producer, representing the server, must make all the choices for the client.

The video producer, forced into this situation, chooses a few common formats and bit rates, but not necessarily those optimal for a particular viewer. These existing solutions require the video producer to encode the content into multiple streaming formats and attempt to have a streaming format and bit rate that matches the end user. The user selects the format closest to their capability, or goes without if their particular capability is not supported. These solutions also require the producers to stream multiple formats and bit rates, thereby consuming more network bandwidth. In addition, this model of operation depends on programmatic control of streaming media processes in a larger software platform.

The television and cable industry solves a similar problem for an infrastructure designed to handle TV production formats of video and audio. In their solution, the video producer supplies a single high quality video feed to a satellite distribution network. This distribution network has the responsibility for delivering the video to the network affiliates and cable head ends (the “edge” of their network). At this point, the affiliates and cable head ends encode the video in a format appropriate for their viewers. In some cases this means modulating the signal for RF broadcast. At other times it is analog or digital cable distribution. In either case, the video producer does not have to encode multiple times for each end-user format. They know the user is receiving the best quality experience for their device and network connectivity because the encoding is done at the edge by the “last mile” network provider. The last mile is typically used to refer to the segment of a network that is beyond the edge. Last mile providers in the case of TV are the local broadcasters, cable operators, DSS providers, etc. Because the last mile provider operates the network, they know the conditions on the network at all time. They also know the end user's requirements with great precision, since the end user's requirements are dependent in part on the capabilities of the network. With that knowledge about the last mile network and end user requirements, it is easy for the TV providers to encode the content in a way that is appropriate to the viewer's connectivity and viewing device. However, this approach as used in the television and cable industry has not been used with Internet streaming.

FIG. 10 represents the existing architecture for encoding and distribution of streaming media across the Internet, one using a terrestrial Content Delivery Network (CDN), the other using a satellite CDN. While these are generally regarded as the most sophisticated methods currently available for delivering streaming media to broadband customers, a closer examination exposes important drawbacks.

In the currently existing model as shown in FIG. 10, content is produced and encoded by the Content Producer (1002) at the point of origination. This example assumes it is pre-processed and encoded in RealSystem, Microsoft Windows Media, and Apple QuickTime formats, and that each format is encoded in three different bit rates, 56 Kbps, 300 Kbps, and 600 Kbps. Already, nine individual streams (1004) have been created for one discrete piece of content, but at least this much effort is required to reach a reasonably wide audience. The encoded streams (1005) are then sent via a satellite- (1006) or terrestrial-based CDN (1008) and stored on specially designed edge-based streaming media servers at various points of presence (PoPs) around the world.

The PoPs, located at the outer edge of the Internet, are operated by Internet Service Providers (ISPs) or CDNs that supply end users (1024) with Internet connections of varying types. Some will be broadband connections via cable modem (1010, 1012), digital subscriber line (DSL) (1014) or other broadband transmission technology such as ISDN (1016), T-1 or other leased circuits. Non-broadband ISPs (1018, 1020) will connect end users via standard dial-up or wireless connections at 56 Kbps or slower. Encoded streams stored on the streaming servers are delivered by the ISP or CDN to the end user on an as-requested basis.

This method of delivery using edge-based servers is currently considered to be an effective method of delivering streaming media, because once they are stored on the servers, the media files only need to traverse the “last mile” (1022) between the ISP's point of presence and the consumer (1024). This “last mile” delivery eliminates the notoriously unpredictable nature of the Internet, which is often beset with traffic overloads and other issues that cause quality of service problems.

The process illustrated in FIG. 10 is the most efficient way to deliver streaming media today, and meets the needs of narrowband consumers who are willing to accept spotty quality in exchange for free access to content. However, in any successful broadband business model, consumers will pay for premium content and their expectations for quality and consistency will be very high. Unfortunately the present architecture for delivering streaming media places insurmountable burdens on everyone in the value chain, and stands directly in the way of attempts to develop a viable economic model around broadband content delivery.

In contrast, the broadcast television industry has been encoding and delivering premium broadband content to users for many years, in a way that allows all stakeholders to be very profitable. Comparing the distribution models of these two industries will clearly demonstrate that the present architecture for delivering broadband content over the Internet is fundamentally upside down.

FIG. 11 compares the distribution model of television with the distribution model of streaming media.

Content producers (1102) (wholesalers), create television programming (broadband content), and distribute it through content distributors to broadcasters and cable operators (1104) (retailers), for sale and distribution to TV viewers (1106) (consumers). Remarkably, the Internet example reveals little difference between the two models. In the Internet example, Content Producers (1112) create quality streaming media, and distribute it to Internet Service Providers (1114), for sale and distribution to Internet users (1116). So how can television be profitable with this model, while content providers on the Internet struggle to keep from going out of business? The fact that television has been more successful monetizing the advertising stream provides part of the answer, but not all of it. In fact, if television was faced with the same production and delivery inefficiencies that are found in today's streaming media industry, it is doubtful the broadcast industry would exist as it does today. Why? The primary reason can be found in a more detailed comparison between the streaming media delivery model described in FIG. 10, and the time-tested model for producing and delivering television programming to consumers (FIG. 12). The similarities are striking. These are, after all, nothing more than two different approaches to what is essentially the same task—delivering broadband content to end users. But it is the differences that hold the key to why television is profitable and streaming media is not.

FIG. 12 follows the delivery of a single television program. In this example, the program is encoded by the content producer (1202) into a single, digital broadband MPEG-2 stream (1204). The stream (1205) is then delivered via satellite (1206) or terrestrial broadcast networks (1208) to a variety of local broadcasters, cable operators and Direct Broadcast Satellite (DBS) providers around the country (1210a-1210d). Those broadcasters receive the single MPEG-2 stream (1205), then “re-encode” it into an “optimal” format based on the technical requirement of their local transmission system. The program is then delivered to the television viewer (1224) over the last-mile (1222) cable or broadcast television connection.

Notice that the format required by end users is different for each broadcaster, so the single MPEG-2 stream received from the content provider must be re-encoded into the appropriate optimal format prior to delivery to the home. Broadcasters know that anything other than a precisely optimized signal will degrade the user experience and negatively impact their ability to generate revenue. Remember, it's the broadcaster's function as a retailer to sell the content in various forms to viewers (analog service, digital service, multiple content tiers, pay-per-view, etc)- and poor quality is very difficult to sell.

Comparing Both Delivery Models

Even a quick analysis at this point shows some important similarities between the broadcast and streaming media models. In both models, end users (consumers) require widely varying formats based on the requirements of their viewing device. For example, in the broadcast model (FIG. 12), customers of CATV Provider (a), have a digital set-top box at their TV that requires a 4 Mbps CBR digital MPEG-2 stream. CATV Provider (c) subscribers need a 6 MHz analog CATV signal. DBS (b) subscribers receive a 3-4 Mbps VBR encoded digital MPEG-2 stream, and local broadcast affiliate viewers (d) must get a modulated RF signal over the air. This pattern of differing requirements is consistent across the industry.

End users in the Internet model (FIG. 10) likewise require widely varying formats based on the requirements of their viewing device and connection, but here the variance is even more pronounced. Not only do they need different formats (Real, Microsoft, QuickTime, etc.), they also require the streams they receive to be optimized for different spatial resolutions (picture size), temporal resolutions (frame rate) and bit rates (transmission speed). Furthermore, these requirements fluctuate constantly based on network conditions across the Internet and in the last-mile.

While end users in both models require different encoded formats in order to view the same content, what is important is the difference in how those requirements are satisfied. In the current model, Streaming media is encoded at the source, where nothing is known about the end user's device or connection. Broadcasters encode locally, where the signal can be optimized fully according to the requirements of the end user.

Lowest common denominator

To receive an “optimal” streaming media experience, end users must receive a stream that has been encoded to the specific requirements of their device, connection type, and speed. This presents a significant challenge for content producers, because in the current streaming media model, content is encoded at the source in an effort to anticipate what the end-user might need—even though from this vantage point, almost nothing is known about the specific requirements of the end user. Exacerbating the problem is the fact that format and bandwidth requirements vary wildly throughout the Internet, creating an unmanageable number of “optimum” combinations.

This “guessing game” forces content producers to make a series of compromises in order to maximize their audience reach, because it would require prohibitive amounts of labor, computing power, and bandwidth to produce and deliver streams in all of the possible formats and bit rates required by millions of individual consumers. Under these circumstances, content producers are compelled to base their production decisions on providing an “acceptable” experience to the widest possible audience, which in most cases means producing a stream for the lowest common denominator (LCD) set of requirements. The LCD experience in streaming media is the condition where the experience of all users is defined by the requirements of the least capable.

One way to overcome this limitation is to produce more streams, either individually or through multiple bit rate encoding. But since it is logistically and economically impossible to produce enough streams to meet all needs, the number of additional streams produced is usually limited to a relatively small set in a minimal number of bit rates and formats. This is still a lowest common denominator solution, since this limited offering forces end users to select a stream that represents the least offensive compromise. Whether it's one or several, LCD streams almost always result in a sub-optimal experience for viewers, because they rarely meet the optimum technical requirements of the end user's device and connection.

Consider the following example.

Assume a dial-up Internet access customer wants to receive a better streaming media experience, and decides to upgrade to a broadband connection offered by the local cable company through a cable modem. The technical capabilities of the cable plant, combined with the number of shared users on this customer's trunk, allow him to receive download speeds of 500 Kbps on a fairly consistent basis. In the present streaming media model of production and delivery (FIG. 10), the content provider has made the business decision to encode and deliver streaming media in three formats, each at 56 Kbps, 300 Kbps, and 600 Kbps. Already its obvious that this customer will not be receiving an “optimal” experience, since the available options (56 Kbps, 300 Kbps, and 600 Kbps) do not precisely match his actual connection speed. Instead, he will be provided the next available option—in this case, 300 Kbps. This is an LCD stream, because it falls at the bottom of the range of available options for this customer's capabilities (300 Kbps-600 Kbps). In the present content encoding and delivery architecture, nearly everyone who views streaming media receives an LCD stream, or worse.

What could be worse than receiving an LCD stream? Consider the following.

Continuing the above example, assume that for some reason (flash traffic, technical problems, temporary over-subscription, etc.) the available bandwidth in the last mile falls, dropping the customer's average connection speed to 260 Kbps. Although the cable company is aware of this change, there is nothing they can do about adjusting the parameters of the available content, since content decisions are made independently by the producer way back at the point of origination, while use and allocation of last-mile bandwidth are business decisions made by the broadband ISP based on technological and cost constraints. This makes the situation for our subscriber considerably worse. If he were watching a stream encoded precisely for a 260 Kbps connection, the difference in quality would hardly be noticeable. But in the above example, he is now watching a 300K stream that is being forced to drop to 260K. This best-effort technique, also known as scaling or stream-thinning, is an inelegant solution that results in a choppy, unpredictable experience.

What else could be worse than receiving an LCD stream?

Receiving no stream at all. Some end user requirements are so specialized that content producers choose to ignore those users altogether. Wireless streaming provides an excellent example. There are many different types of devices with many different form factors (color depth, screen size, etc.). Additionally, there is tremendous variability in bandwidth as users move throughout the wireless coverage area. With this amount of variance in end user requirements, content producers can't even begin to create and deliver optimized streams for all of them, so content producers are usually forced to ignore wireless altogether. This is an unfortunate consequence, since wireless users occupy the prime demographic for streaming media. They are among the most likely to use it, and the best situated to pay for it.

The only way to solve all of these problems is to deliver a stream that is encoded to match the requirements of each user. Unfortunately, the widely varying conditions in the last mile can never be adequately addressed by the content provider, located all the way back at the point of origination.

But broadcasters understand this. In the broadcast model (FIG. 12), content is encoded into a single stream at the source, then delivered to local broadcasters who encode the signal into the optimum format based on the characteristics of the end user in the last mile. This ensures that each and every user enjoys the highest quality experience allowed by the technology. It is an architecture that is employed by every broadcast content producer and distributor, whether they are a cable television system, broadcast affiliate or DBS provider, and it leverages a time-tested, proven delivery model: encode the content for final delivery at the point of distribution, the edge of the network, where everything is known about each individual customer.

For broadcasters, it would be impractical to do it any other way. Imagine if each of the thousands of broadcasters and cable operators in this country demanded that the content provider send them a separate signal optimized for their specific, last-mile requirements. Understandably, the cost of content would rise far above the ability of consumers to pay for it. This is the situation that exists today in the model for streaming media over the Internet, and it is both technically and economically upside-down.

Business Aspects

A comparable analysis applies to the business aspects of distributing streaming media. FIG. 13 provides some insight into the economics of producing and delivering rich media content, both television and broadband streaming media.

In the broadcast model shown in FIG. 13, costs are incurred by the content producer (1302), since the content must be prepared and encoded prior to delivery. Costs are also incurred in the backbone, since transponders must be leased and/or bandwidth must be purchased from content distributors (1304). Both of these costs are paid by the content provider. On the local broadcaster or cable operator's segment (1306), often referred to as the “last-mile”, revenue is generated. Of course, a fair portion of that revenue is returned to the content provider sufficient to cover costs and generate profit. Most importantly, in the broadcast model, both costs and revenue are distributed evenly among all stakeholders. Everyone wins.

While the economic model of streaming broadband media on the Internet is similar, distribution of costs and revenue is not. In this mode, virtually all costs —production, preparation, encoding, and transport—are incurred by the content producer (1312). The only revenue generated is in the last-mile (1316), and it is for access only. Little or no revenue is generated from the content to be shared with the content producer (1312). Why?

Some experts blame the lack of profitability in the streaming media industry on slow broadband infrastructure deployment. But this explanation confuses the cause with the effect. In the present model it is too expensive to encode content, and too expensive to deliver it. Regardless of how big the audience gets, content providers will continue to face a business decision that has only two possible outcomes, both bad: either create optimal streams for every possible circumstance, increasing production and delivery costs exponentially; or create only a small number of LCD streams, greatly reducing the size of the audience that can receive a bandwidth-consistent, high-quality experience.

For these reasons, it will never be economically feasible to produce sufficient amounts of broadband and wireless streaming media content that is optimized for a sufficiently large audience using the present model. And as long as it remains economically impossible to produce and deliver it, consumers will always be starved for high-quality broadband content. All the last-mile bandwidth in the world will not solve this problem. The present invention addresses the limitations of the prior art.

The following are further objects of the invention:

To provide a distribution mechanism for streaming media that delivers a format and bit rate matched to the user's needs.

To make streaming media available to a wider range of devices by allowing multiple formats to be created in an economically efficient manner.

To reduce the bandwidth required for delivery of streaming media from the content provider to the local distributor.

To provide the ability to insert localized content at the point of distribution, such as local advertising.

To provide a means whereby the distributor may participate financially in content-related revenue, such as by selling premium content at higher prices, and/or inserting local advertising.

To provide a processing regime that avoids unnecessary digital to analog conversion and reconversion.

To provide a processing regime with the ability to control attributes such as temporal and spatial scaling to match the requirements of the content.

To provide a processing regime in which processing steps are sequenced for purposes of increased computational efficiency and flexibility.

To provide a processing system in which workflow can be controlled and processing resources allocated in a flexible and coordinated manner.

To provide a processing system that is scalable.

To provide a processing regime that is automated.

Finally, it is a further object of the present invention to provide a method for taking source video in a variety of standard formats, preprocessing the video, converting the video into a selectable variety of encoded formats, performing such processing on a high-performance basis, including real time operation, and providing, in each output format, video characteristics that are well matched to the content being encoded, as well as the particular requirements of the encoder.

### BRIEF SUMMARY OF THE INVENTION

The foregoing and other objects of the invention are accomplished with the present invention. In one embodiment, the present invention reflects a robust, scalable approach to coordinated, automated, real-time command and control of a distributed processing system. This is effected by a three-layer control hierarchy in which the highest level has total control, but is kept isolated from direct interaction with low-level task processes. This command and control scheme comprises a high-level control system, one or more local control systems, and one or more “worker” processes under the control of each such local control system, wherein, a task-independent representation is used to pass commands from the high-level control system to the worker processes, each local control system is interposed to receive the commands from the high level control system, forward the commands to the worker processes that said local control system is in charge of, and report the status of those worker processes to the high-level control system; and the worker processes are adapted to accept such commands, translate the commands to a task-specific representation, and report to the local control system the status of execution of the commands.

In a preferred embodiment, the task-independent representation employed to pass commands is an XML representation. The commands passed to the worker processes from the local control system comprise commands to start the worker's job, kill the worker's job, and report on the status of the worker job. The high-level control system generates the commands that are passed down through the local control system to the worker processes by interpreting a job description passed from an external application, and monitoring available resources as reported to it by the local control system. The high-level control system has the ability to process a number ofjob descriptions simultaneously.

In an alternate embodiment, one or more additional, distributed, high-level control systems are deployed, and portions of a job description are assigned for processing by different high-level control systems. In such embodiment, one high-level control system has the ability to take over the processing for any of the other of said high-level control systems that might fail, and can be configured to do so automatically.

Regarding the video processing aspects of the invention, the foregoing and other objects of the invention are achieved by a method whereby image spatial processing and scaling, temporal processing and scaling, and color adjustments, are performed in a computationally efficient sequence, to produce video well matched for encoding. In one embodiment of the invention, efficiencies are achieved by separating horizontal and vertical scaling, and performing horizontal scaling prior to field-to-field correlations, optional spatial deinterlacing, temporal field association or temporal smoothing, and further efficiencies are achieved by performing spatial filtering after both horizontal and vertical resizing.

Other objects of the invention are accomplished by additional aspects of a preferred embodiment of the present invention, which provide a dynamic, adaptive edge-based encoding™ to the broadband and wireless streaming media industry. The present invention comprises an encoding platform that is a fully integrated, carrier-class solution for automated origination- and edge-based streaming media encoding. It is a customizable, fault tolerant, massively scalable, enterprise-class platform. It addresses the problems inherent in currently available streaming media, including the issues of less-than-optimal viewing experience by the user and excessive consumption of network bandwidth.

In one aspect, the invention involves an encoding platform with processing and workflow characteristics that enable flexible and scalable configuration and performance. This platform performs image spatial processing and resealing, temporal processing and rescaling, and color adjustments, in a computationally efficient sequence, to produce video well matched for encoding, and then optionally performs the encoding. The processing and workflow methods employed are characterized in their separation of overall processing into two series of steps, one series that may be performed at the input frame rate, and a second series that may be performed at the output frame rate, with a FIFO buffer in between the two series of operations. Furthermore computer coordinated controls are provided to adjust the processing parameters in real time, as well as to allocate processing resources as needed among one or more simultaneously executing streaming encoders.

Another aspect of the present invention is a distribution system and method which allows video producers to supply improved live streaming experience to multiple simultaneous users independent of the users' individual viewing device, network connectivity, bit rate and supported streaming formats by generating and distributing a single live Internet stream to multiple edge encoders that convert this stream into formats and bit rates matched to that for each viewer. This method places the responsibility for encoding the video and audio stream at the edge of the network where the encoder knows the viewer's viewing device, format, bit rate and network connectivity, rather than placing the burden of encoding at the source where they know little about the end user and must therefore generate a few formats that are perceived to be the “lowest common denominator”.

In one embodiment of the present invention, referred to as “edge encoding,” a video producer generates a live video feed in one of the standard video formats. This live feed enters the Source Encoder, where the input format is decoded and video and audio processing occurs. After processing, the data is compressed and delivered over the Internet to the Edge Encoder. The Edge Encoder decodes the compressed media stream from its delivery format and further processes the data by customizing the stream locally. Once the media has been processed locally, it is sent to one or more streaming codecs for encoding in the format appropriate to the users and their viewing devices. The results of the codecs are sent to the streaming server to be viewed by the end users in a format matched to their particular requirements.

The system employed for edge encoded distribution comprises the following elements:

an encoding platform deployed at the point of origination, to encode a single, high bandwidth compressed transport stream and deliver it via a content delivery network to encoders located in various facilities at the edge of the network;

one or more edge encoders, to encode said compressed stream into one or more formats and bit rates based on the policies set by the content delivery network or edge facility;

an edge resource manager, to provision said edge encoders for use, define and modify encoding and distribution profiles, and monitor edge-encoded streams; and

an edge control system, for providing command, control and communications across collections of said edge encoders.

A further aspect of the edge encoding system is a distribution model that provides a means for local network service provider to participate in content-related revenue in connection with the distribution to user of streaming media content originating from a remote content provider. This model involves performing streaming media encoding for said content at said service provider's facility; performing, at the service provider's facility, processing steps preparatory to said encoding, comprising insertion of local advertising; and charging a fee to advertisers for the insertion of the local advertising. Further revenue participation opportunities for the local provider arise from the ability on the part of the local entity to separately distribute and price “premium” content.

The manner in which the invention achieves these and other objects is more particularly shown by the drawings enumerated below, and by the detailed description that follows.

### BRIEF DESCRIPTION OF THE DRAWINGS

The following briefly describes the accompanying drawings:

FIGS. 1A and 1B are functional block diagrams depicting alternate embodiments of prior art distributed systems for processing and distributing streaming media.

FIG. 2 is a functional block diagram shows the architecture of a distributed process system which is being controlled by the techniques of the present invention.

FIG. 3A is a detailed view of one of the local processing elements shown in FIG. 2, and FIG. 3B is a version of such an element with sub-elements adapted for processing streaming media.

FIG. 4 is a logical block diagram showing the relationship among the high-level “Enterprise Control System,” a mid-level “Local Control System,” and a “worker” process.

FIG. 5 is a diagram showing the processing performed within a worker process to translate commands received in the format of a task-independent language into the task-specific commands required to carry out the operations to be performed by the worker.

FIG. 6 is a flow chart showing the generation of a job plan for use by the Enterprise Control System.

FIGS. 7A and 7B are flow charts representing, respectively, typical and alternative patterns of job flow in the preferred embodiment.

FIG. 8 is a block diagram showing the elements of a system for practicing the present invention.

FIG. 9 is a flow chart depicting the order of processing in the preferred embodiment.

FIG. 10 represents the prior art architecture for encoding and distribution of streaming media across the Internet.

FIG. 11 compares the prior art distribution models for television and streaming media.

FIG. 12 depicts the prior art model for producing and delivering television programming to consumers.

FIG. 13 represents the economic aspects of prior art modes of delivering television and streaming media.

FIG. 14 represents the architecture of the edge encoding platform of the present invention.

FIG. 15 represents the deployment model of the edge encoding distribution system.

FIG. 16 is a block diagram representing the edge encoding system and process.

FIG. 17 is a block diagram representing the order of video preprocessing in accordance with an embodiment of the present invention.

FIG. 18 is a block diagram depicting workflow and control of workflow in the present invention.

### DETAILED DESCRIPTION OF THE INVENTION

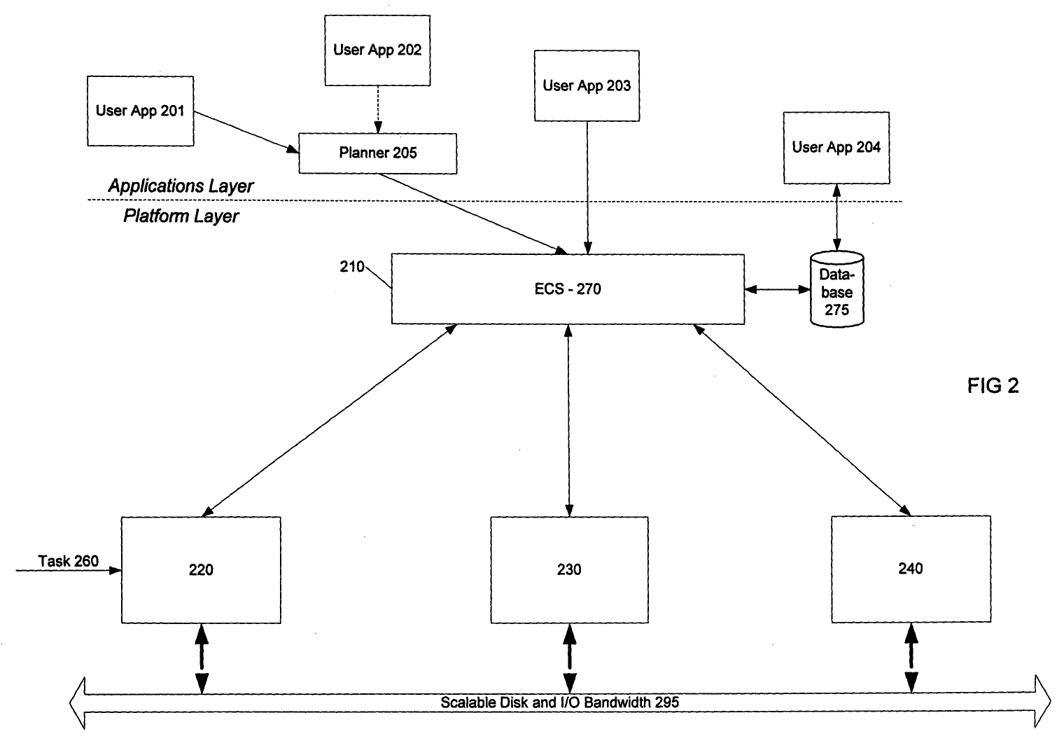

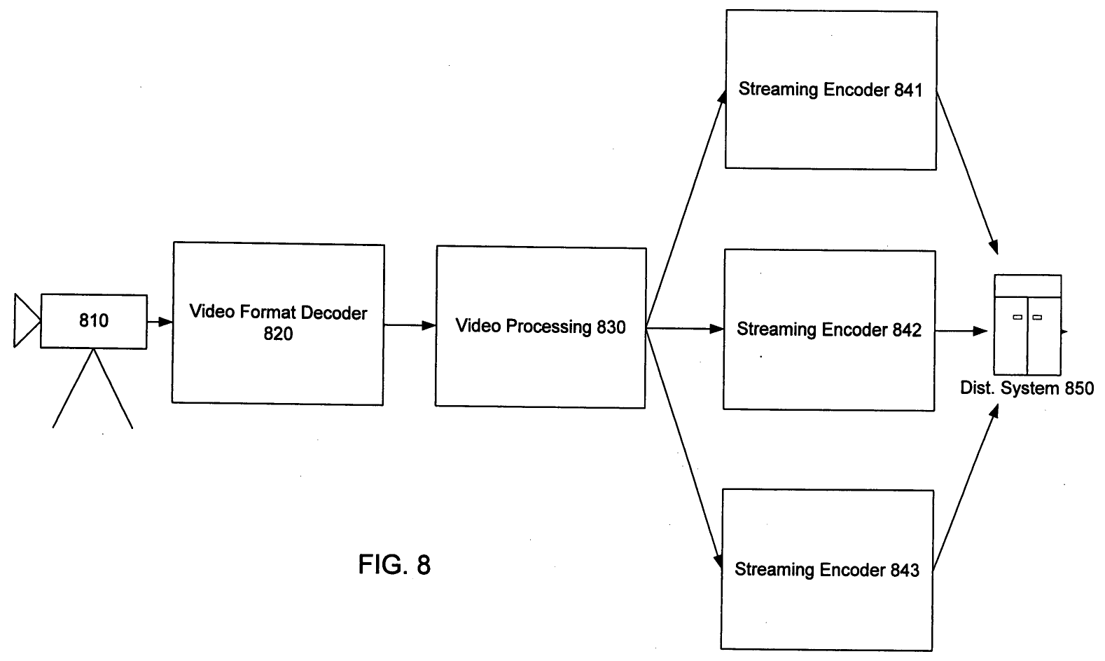

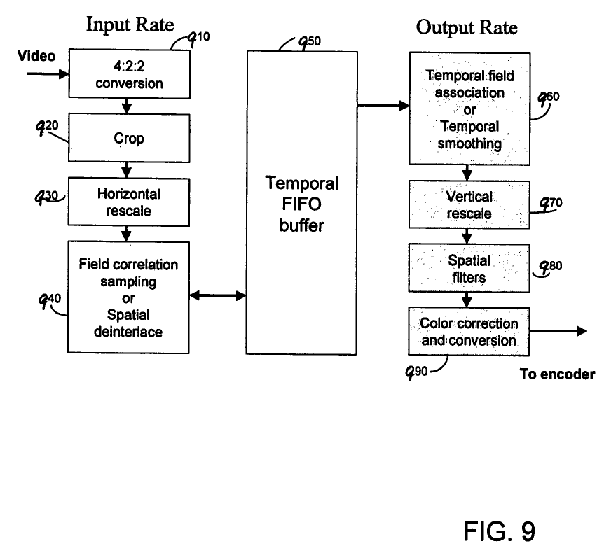

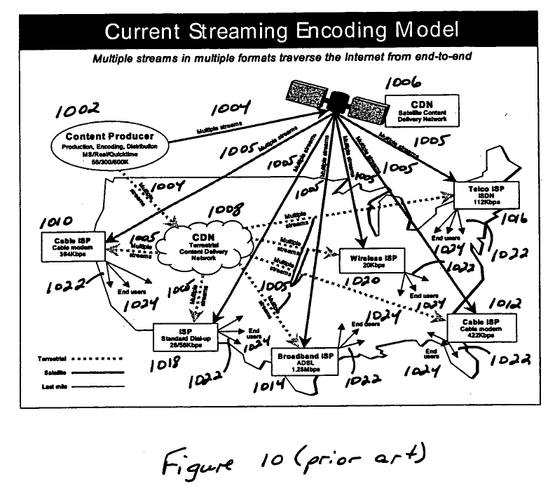

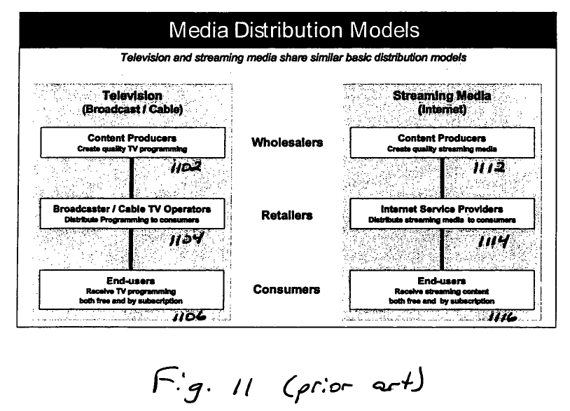

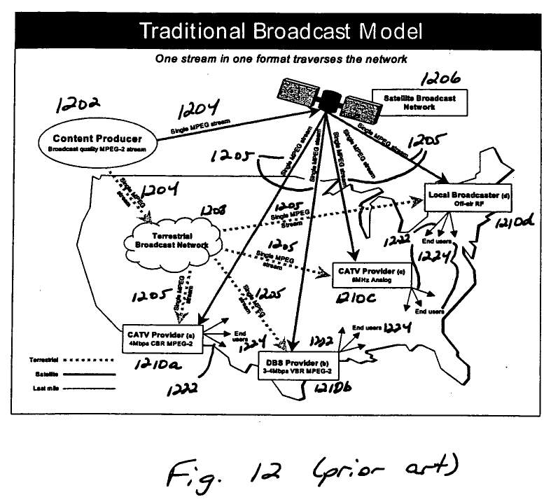

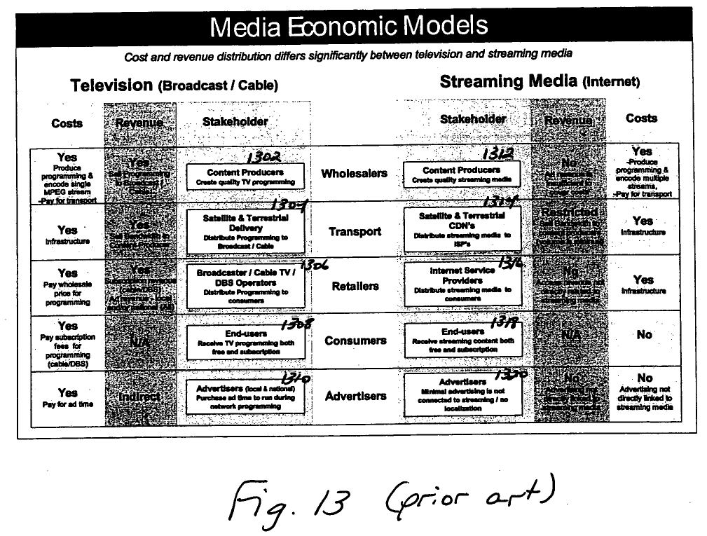

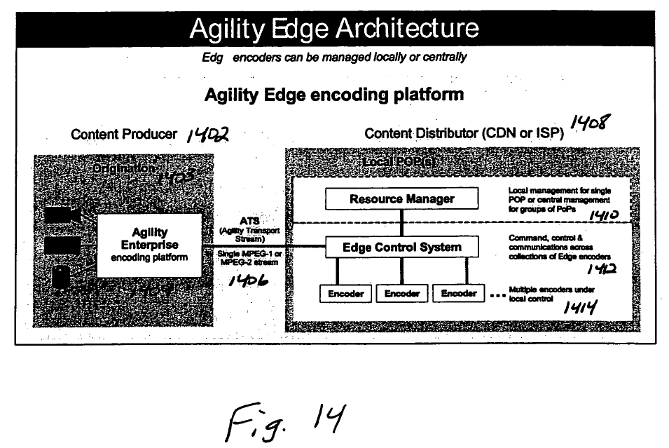

A preferred embodiment of the workflow aspects of the invention is illustrated in FIGS. 2-7, and is described in the text that follows. A preferred embodiment of the video processing aspects of the invention is illustrated in FIGS. 8 and 9, and is described in the text that follows. A preferred embodiment of the edge-encoded streaming media aspects of the invention is shown in FIGS. 14-18, and is described in the text that follows. Although the invention has been most specifically illustrated with particular preferred embodiments, its should be understood that the invention concerns the principles by which such embodiments may be constructed and operated, and is by no means limited to the specific configurations shown.

Command and Control System

In particular, the embodiment for command and control that is discussed in greatest detail has been used for processing and distributing streaming media. The inventors, however, have also used it for controlling a distributed indexing process for a large collection of content—an application far removed from processing and distributing streaming media. Indeed, the present invention addresses the general issue of controlling distributed processes, and should not be understood as being limited in any way to any particular type of class of processing.

In general, the technique by which the present invention asserts command and control over a distributed process system involves a logically layered configuration of control levels. An exemplary distributed process system is shown in block diagram form in FIG. 2. The figure is intended to be representative of a system for performing any distributed process. The processing involved is carried out on one or more processors, 220, 230, 240, etc. (sometimes referred to as “local processors”, though they need not in fact be local), any or all of which may themselves be multitasking. A application (201, 202) forwards a general purpose description of the desired activity to a Planner 205, which generates a specific plan in XML format ready for execution by the high-level control system, herein referred to as the “Enterprise Control System” or “ECS” 270 (as discussed below in connection with an alternate embodiment, a system may have more than one ECS). The ECS itself runs on a processor (210), shown here as being a distinct processor, but the ECS could run within any one of the other processors in the system. Processors 220, 230, 240, etc. handle tasks such as task 260, which could be any processing task, but which, for purposes of illustration, could be, for example, a feed of a live analog video input. Other applications, such as one that merely monitors status (e.g., User App 203), does not require the Planner, and, as shown in FIG. 2, may communicate directly with the ECS 270. The ECS stores its tasks to be done, and the dependencies between those tasks, in a relational database (275). Other applications (e.g. User App. 204) may bypass the ECS and interact directly with database 275, for example, an application that queries the database and generates reports.

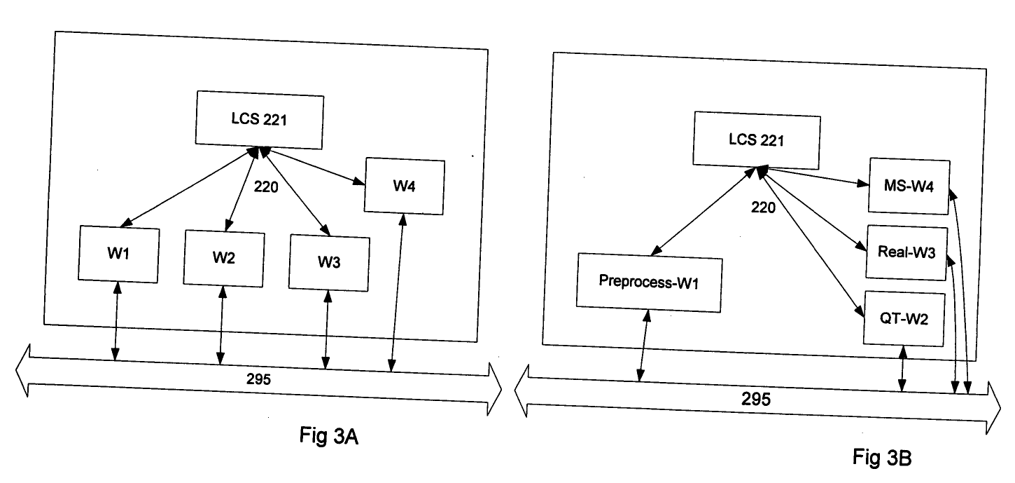

FIG. 3A shows a more detailed block diagram view of one of the processors (220). Processes running on this processor include a mid-level control system, referred to as the “Local Control System” or “LCS” 221, as well as one or more “worker” processes W1, W2, W3, W4, etc. Not shown are subprocesses which may run under the worker processes, consisting of separate or third-party supplied programs or routines. In the streaming media production example used herein (shown alternatively in FIG. 3B), there could be a video preprocessor worker W1 and further workers W2, W3, W4, etc., having as subprocesses vendor-specific encoders, such as (for example) streaming encoders for Microsoft® Media, Real® Media, and/or Quicktime®.

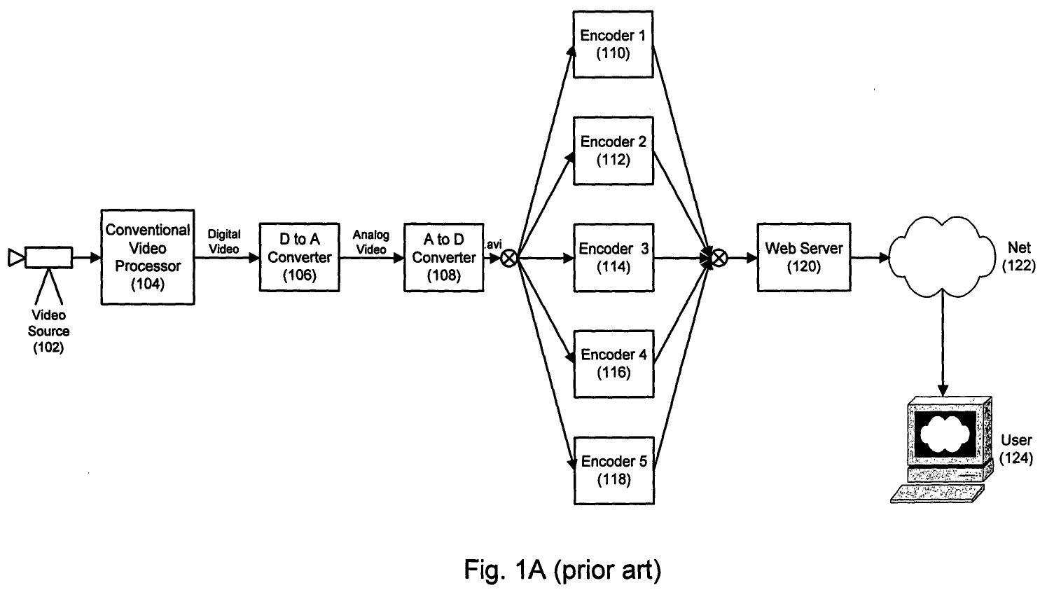

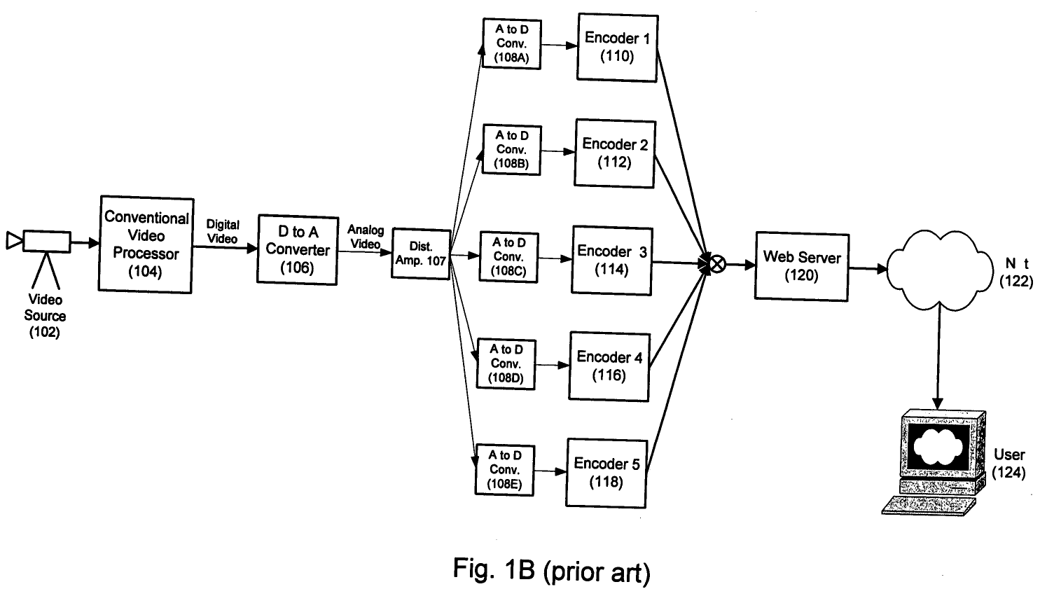

In the example system, the output of the distributed processing, even given a single, defined input analog media stream, is highly variable. Each user will have his or her own requirements for delivery format for streaming media, as well as particular requirements for delivery speed, based on the nature of the user's network connection and equipment. Depending on the statistical mix of users accessing the server at any given time, demand for the same media content could be in any combination of formats and delivery speeds. In the prior art (FIGS. 1A, 1B), processors were dedicated to certain functions, and worker resources such as encoders could be invoked on their respective processors through an Object Request Broker mechanism (e.g., CORBA). Nevertheless, the invocation itself was initiated manually, with the consequence that available encodings were few in number and it was not feasible to adapt the mix of formats and output speeds being produced in order to meet real time traffic needs.

The present invention automates the entire control process, and makes it responsive automatically to inputs such as those based on current user loads and demand queues. The result is a much more efficient, adaptable and flexible architecture able reliably to support much higher sustained volumes of streaming throughput, and to satisfy much more closely the formats and speeds that are optimal for the end user.

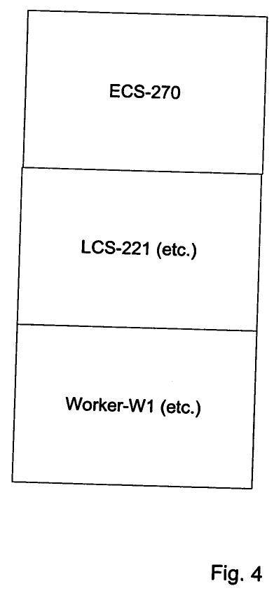

The hierarchy of control systems in the present invention is shown in FIG. 4. The hierarchy is ECS (270) to one of more LCS processes (221, etc.) to one or more worker processes (W1, etc.).

The ECS, LCS and workers communicate with one another based on a task-independent language, which is XML in the preferred embodiment. The ECS sends commands to the LCS which contain both commands specific to the LCS, as well as encapsulated XML portions that are forwarded to the appropriate workers.

The ECS 270 is the centralized control for the entire platform. Its first responsibility is to take job descriptions specified in XML, which is a computer platform independent description language, and then break each job into its component tasks. These tasks are stored in a relational database (275) along with the dependencies between the tasks. These dependencies include where a task can run, what must be run serially, and what can be done in parallel. The ECS also monitors the status of all running tasks and updates the status of the task in the database. Finally, the ECS examines all pending tasks whose preconditions are complete and determines if the necessary worker can be started. If the worker can be started, the ECS sends the appropriate task description to the available server and later monitors the status returning from this task's execution. The highest priority job is given a worker in the case where this worker is desired by multiple jobs. Further, the ECS must be capable of processing a plurality of job descriptions simultaneously.

Each server (220, 230, 240, etc.) has a single LCS. It receives XML tasks descriptions from the ECS 270 and then starts the appropriate worker to perform the task. Once the task is started, it sends the worker its task description for execution and then returns worker status back to the ECS. In the unlikely situation where a worker prematurely dies, the LCS detects the worker failure and takes the responsibility for generating its own status message to report this failure and sending it to the ECS.

The workers shown in FIGS. 3A and 3B perform the specific tasks. Each worker is designed to perform one task such as a Real Media encode or a file transfer. Each class of worker (preprocessing, encoders, file transfer, mail agents, etc.) has an XML command language customized to the task they are supposed to perform. For the encoders, the preferred embodiment platform uses the vendor-supplied SDK (software development kit) and adds an XML wrapper around the SDK. In these cases, the XML is designed to export all of the capability of the specific SDK. Because each encoder has different features, the XML used to define a task in each encoder has to be different to take advantage of features of the particular encoder. In addition to taking XML tasks descriptions to start jobs, each worker is responsible for returning status back in XML. The most important status message is one that declares the task complete, but status messages are also used to represent error conditions and to indicate the percentage complete in the job.

In FIGS. 2, 3A and 3B, each worker is also connected via scalable disk and I/O bandwidth 295. As viewed from the data perspective, the workers form a data pipeline where workers process data from an input stream and generate an output stream. Depending on the situation, the platform of the preferred embodiment uses in-memory connections, disk files, or network based connections to connect the inter-worker streams. The choice of connection depends on the tasks being performed and how the hardware has been configured. For the preferred embodiment platform to scale up with the number of processors, it is imperative that this component of the system also scale. For example, a single 10 Mbit/sec. Ethernet would not be very scalable, and if this were the only technology used, the system would perform poorly as the number of servers is increased.

The relational database 275 connected to the ECS 270 holds all persistent state on the operation of the system. If the ECS crashes at any time, it can be restarted, and once it has reconnected to the database, it will reacquire the system configuration and the status of all jobs running during the crash (alternately, as discussed below, the ECS function can be decentralized or backed up by a hot spare). It then connects to each LCS with workers running, and it updates the status of each job. Once these two steps are complete, the ECS picks up each job where it left off. The ECS keeps additional information about each job such as which system and worker ran the job, when it ran, when it completed, any errors, and the individual statistics for each worker used. This information can be queried by external applications to do such things as generate an analysis of system load or generate a billing report based on work done for a customer.

Above the line in FIG. 2 are the user applications that use the preferred embodiment platform. These applications are customized to the needs and workflow of the video content producer. The ultimate goal of these applications is to submit jobs for encoding, to monitor the system, and to set up the system configuration. All of these activities can either be done via XML sent directly to the system or indirectly by querying the supporting relational database 275.

The most important applications are those that submit jobs for encoding. These are represented in FIG. 2 as User App. 201 and User App. 202. These applications are the most likely to designate a file to encode, the specification of a live input source, or a title, and some manner of determining the appropriate processing to perform (usually called a “profile”). The profile can be fixed for a given submission, or it can selected directly by name, or it may be inferred from other information (such as a category of “news”, or “sports”).

Once all of the appropriate information has been collected, it is sent to the Planner 205 and a job description is constructed. The Planner 205 takes the general-purpose description of the desired activity from the user application and generates a very specific plan ready for execution by the ECS 270. This plan will include detailed task descriptions for each task in the job (such as the specific bit-rates, or whether the input should be de-interlaced). Since the details of how ajob should be described vary from application to application, multiple Planners must be supported. Since the Planners are many, and usually built in conjunction with the applications they support, they are placed in the application layer instead of the platform layer.

FIG. 2 shows two other applications. User App. 203 is an application that shows the user status of the system. This could be either general system status (what jobs are running where) or specific status on jobs of interest to users. Since these applications do not need a plan, they connect directly to the ECS 270. User App. 204 is an application that bypasses ECS 270 altogether, and is connected to the relational database 275. These types of applications usually query past events and generate reports.

The LCS is a mid-level control subsystem that typically executes as a process within local processors 220, 230, 240, etc., although it is not necessary that LCS processes be so situated. Among the tasks of the LCS are to start workers, kill worker processes, and report worker status to the ECS, so as, in effect, to provide a “heartbeat” function for the local processor. The LCS must also be able to catalog its workers and report to the ECS what capabilities it has (including parallel tasking capabilities of workers), in order for the ECS to be able to use such information in allocating worker processing tasks.

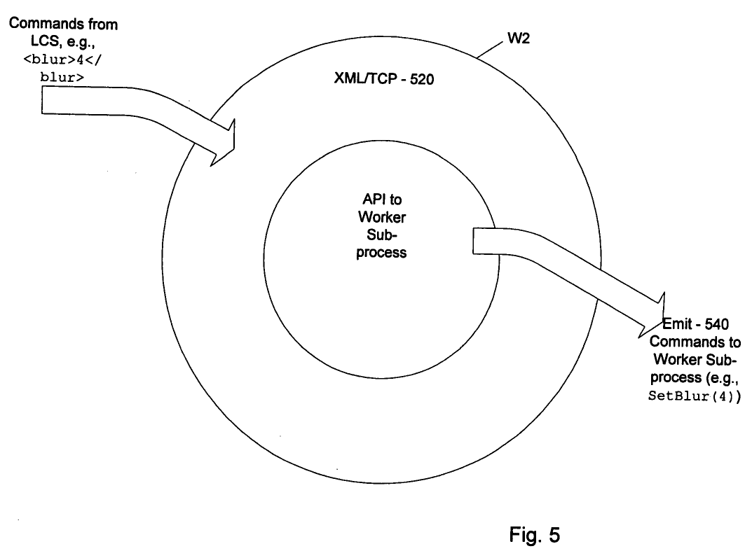

FIG. 5 depicts processing of the control XML at the worker level. Here an incoming command 510 from the LCS (for example, the XML string <blur>4</blur> is received by worker W2 via TCP/IP sockets 520. Worker W2 translates the command, which up to this point was not task specific, into a task-specific command required for the worker's actual task, in this case to run a third-party streaming encoder. Thus (in the example being shown), the command is translated into the task-specific command 540 from the encoder's API, i.e., “SetBlur(4)”.

As noted above, the present invention is not limited to systems having one ECS. An ECS is a potential point of failure, and it is desirable to ameliorate that possibility, as well as to provide for increased system capacity, by distributing the functions of the ECS among two or more control processes. This is done in an alternate embodiment of the invention, which allows, among other things, for the ECS to have a “hot spare”.

The following describes the functions of the ECS and LCS, the protocols and formats of communications from the user application to the ECS, and among the ECS, LCS and workers, and is followed by a description of notification and message formats employed in the preferred embodiment.

Enterprise Control System (ECS)

Job Descriptions

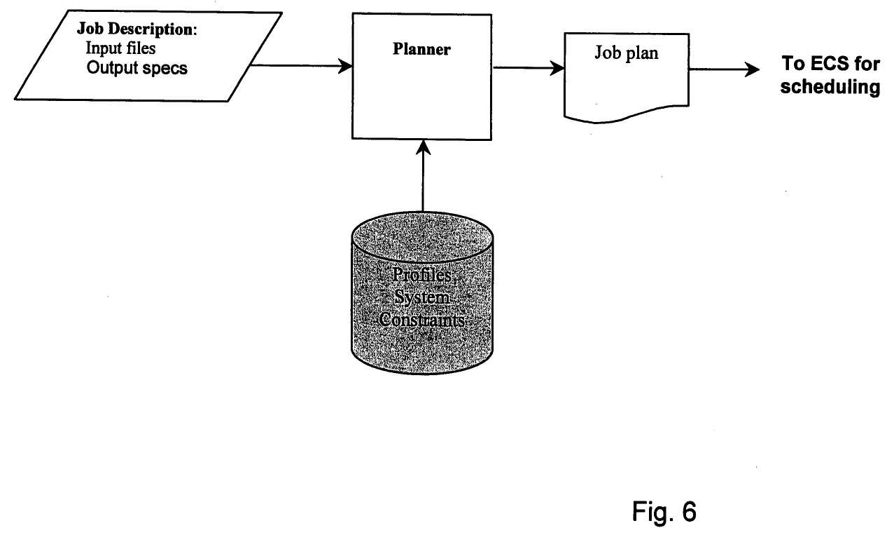

In an effort to make individual job submissions as simple as possible, the low-level details of how a job is scheduled is generally hidden from the end user. Instead, the user application (e.g., 201) simply specifies (for example) a video clip and desired output features, along with some related data, such as author and title. This job description is passed to a Planner (205), which expands the input parameters into a detailed plan—expressed in MML—for accomplishing the goals. See FIG. 6. (Alternately, the user could submit the MML document to Planner 205 directly).

Job Plans

All encoding activity revolves around the concept of a job. Each job describes a single source of content and the manner in which the producer wants it distributed. From this description, the Planner 205 generates a series of tasks to convert the input media into one or more encoded output streams and then to distribute the output streams to the appropriate streaming server. The encoded output streams can be in different encoded formats, at different bit rates and sent to different streaming servers. The job plan must have adequate information to direct all of this activity.

Workers

Within the platform of the preferred embodiment, the individual tasks are performed by processes known as workers. Encoding is achieved through two primary steps: a preprocessing phase performed by a prefilter worker, followed by an encoding phase. The encoding phase involves specialized workers for the various streaming formats. Table 1 summarizes all the workers used in one embodiment.

TABLE 1
Workers

| Worker Name | Function | Description |
|---|---|---|
| prefilter | preprocessing | Preprocesses a video file or live video capture |
| (specialized | | (from camera or tape deck), performing |
| workers for | | enhancements such as temporal smoothing. |
| individual live- | | This phase is not always strictly required, but |
| capture stations | | should be performed to guarantee that the input |
| have names of the | | files are in an appropriate format for the encoders. |
| form “lc<N>pp”, | | |
| such as lc1pp.) | | |
| Microsoft | Encoding | Encodes .avi files into Microsoft streaming formats. |
| Real | Encoding | Encodes .avi files into Real streaming formats. |
| Quicktime | Encoding | Encodes .avi files into Quicktime streaming |
| | | formats. |
| Fileman | file | Moves or deletes local files. Distributes files via |
| | management | FTP. |
| Anymail | e-mail | Sends e-mail. Used to send notifications of job |
| | | completion or failure. |

Scheduling

The job-plan MML uses control tags in order to lay out the order of execution of the various tasks. A skeleton framework would look as shown in Listing A.

```
<job>
  <priority>2</priority>
  <title>My Title</title>
  <author>J. Jones</author>
  <notify>
    <condition>failure</condition>
    <plan>
      . . . some worker action(s) . . .
    </plan>
  </notify>
  <plan>
    . . . some worker action(s) . . .
  </plan>
</job>
```

Listing A

The optional <notify> section includes tasks that are performed after the tasks in the following <plan> are completed. It typically includes email notification of job completion or failure.

Each <plan> section contains a list of worker actions to be taken. The actions are grouped together by job control tags that define the sequence or concurrency of the actions: <parallel> for actions that can take place in parallel, and <serial> for actions that must take place in the specified order. If no job-control tag is present, then <serial> is implied.

A typical job-flow for one embodiment of the invention is represented in Listing B.

```
<job>
  <priority>2</priority>
  <title>My Title</title>
  <author>J. Jones</author>
  <notify>
    <condition>failure</condition>
    <plan>
      <anymail>
        . . . email notification . . .
      </anymail>
    </plan>
  </notify>
  <plan>
    <prefilter>
      . . . preprocessing . . .
    </prefilter>
    <parallel>
      <microsoft>
        . . . Microsoft encoding . . .
      </microsoft>
      <real>
        . . . Real encoding . . .
      </real>
      <quicktime>
        . . . Quicktime encoding . . .
      </quicktime>
    </parallel>
    <parallel>
      <fileman>
        . . . FTP of Microsoft files . . .
      </fileman>
      <fileman>
        . . . FTP of Real files . . .
      </fileman>
      <fileman>
        . . . FTP of Quicktime reference file . . .
      </fileman>
      <fileman>
        . . . FTP of Quicktime stream files . . .
      </fileman>
    </parallel>
  </plan>
</job>
```

Listing B

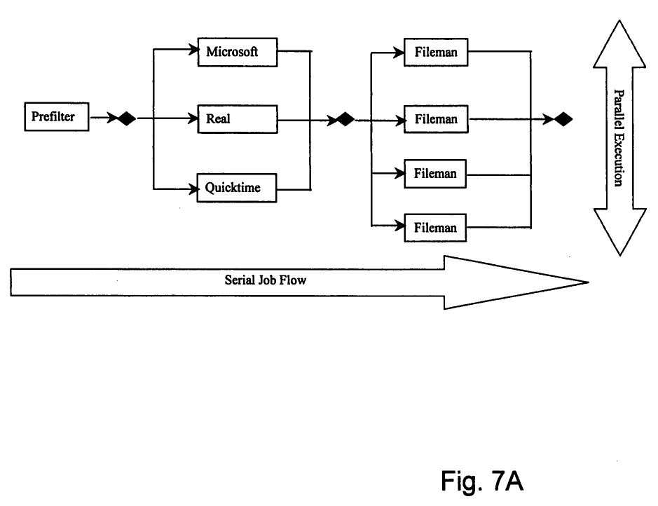

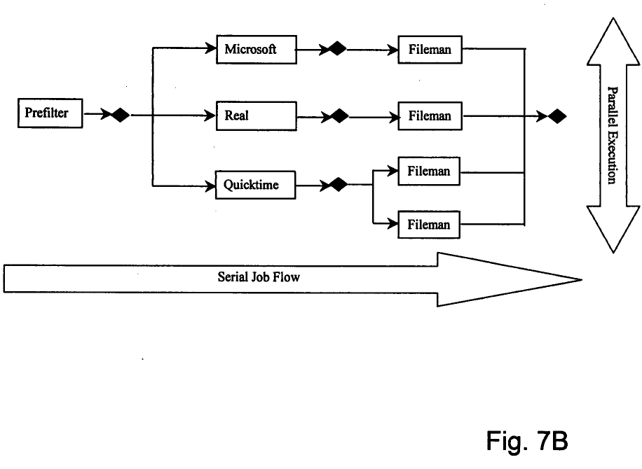

Graphically, this job flow is depicted in FIG. 7A. In FIG. 7A, each diamond represents a checkpoint, and execution of any tasks that are “downstream” of the checkpoint will not occur if the checkpoint indicates failure. The checkpoints are performed after every item in a <serial> list.

Due to the single checkpoint after the parallel encoding tasks, if a single encoder fails, none of the files from the successful encoders are distributed by the fileman workers. If this were not the desired arrangement, the job control could be changed to allow the encoding and distribution phases to run in parallel. The code in Listing C below is an example of such an approach.

```
<job>
  <priority>2</priority>
  <title>My Title</title>
  <author>J. Jones</author>
  <notify>
    <condition>failure</condition>
    <plan>
      <anymail>
        . . . email notification . . .
      </anymail>
    </plan>
  </notify>
  <plan>
    <prefilter>
      . . . preprocessing . . .
    </prefilter>
    <parallel>
      <serial>
        <microsoft>
          . . . Microsoft encoding . . .
        </microsoft>
        <fileman>
          . . . FTP of Microsoft files . . .
        </fileman>
      </serial>
      <serial>
        <real>
          . . . Real encoding . . .
        </real>
        <fileman>
          . . . FTP of Real files . . .
        </fileman>
      </serial>
      <serial>
        <quicktime>
          . . . Quicktime encoding . . .
        </quicktime>
        <parallel>
          <fileman>
            . . . FTP of Quicktime reference file . . .
          </fileman>
          <fileman>
            . . . FTP of Quicktime stream files . . .
          </fileman>
        </parallel>
      </serial>
    </parallel>
  </plan>
</job>
```

Listing C

The resulting control flow is shown in FIG. 7B. In this job flow, the Microsoft and Real files will be distributed even if the Quicktime encoder fails, since their distribution is only dependent upon the successful completion of their respective encoders.

Job Submission Details

For a job description to be acted upon, it must be submitted to the Enterprise Control System 270. In the typical configuration of the preferred embodiment platform, the Planner module 205 performs this submission step after building the job description from information passed along from the Graphical User Interface (GUI); however, it is also possible for user applications to submit job descriptions directly. To do this, they must open a socket to the ECS on port 3501 and send the job description, along with a packet-header, through the socket.

The Packet Header

The packet header embodies a communication protocol utilized by the ECS and the local control system (LCS) on each processor in the system. The ECS communicates with the LCSs on port 3500, and accepts job submissions on port 3501. An example packet header is shown in Listing D below.

```
<packet-header>
  <content-length>5959</content-length>
  <msg-type>test</msg-type>
  <from>
    <host-name>dc-igloo</host-name>
    <resource-name>submit</resource-name>
    <resource-number>0</resource-number>
  </from>
  <to>
    <host-name>localhost</host-name>
    <resource-name>ecs</resource-name>
    <resource-number>0</resource-number>
  </to>
</packet-header>
```

Listing D

| | |
|---|---|
| <content-length> | |
| Valid Range: | Non-negative integer. |
| Function: | Indicates the total length, in bytes— |
| | including whitespace—of the data |
| | following the packet header. This number must be |
| | exact. |
| <message-type> | |
| Valid Values: | “test” |
| Function: | test |

<from>

This section contains information regarding the submitting process.

| | |
|---|---|
| <host-name> | |
| Valid Values: | A valid host-name on the network, including |
| | “localhost”. |
| Function: | Specifies the host on which the submitting |
| | process is running. |
| <resource-name> | |
| Valid Values: | “submit” |
| Function: | Indicates the type of resource that is |
| | communicating with the ECS. |
| <resource-number> | |
| Valid Range: | Non-negative integer, usually “0” |
| Function: | Indicates the identifier of the resource that |
| | is communicating with the ECS. For submission, |
| | this is generally 0. |

<to>

This section identifies the receiver of the job description, which should always be the ECS.

| | |
|---|---|
| <host-name> | |
| Valid Values: | The hostname of the machine on which |
| | the ECS is running. If the submission process is |
| | running on the same machine, then |
| | “localhost” is sufficient. |
| <resource-name> | |
| Valid Values: | “ecs” |
| Function: | Indicates the type of resource that is |
| | receiving the message. For job submission, this |
| | is always the ECS.. |
| <resource-number> | |
| Valid Range: | 0 |
| Function: | Indicates the resource identifier for |
| | the ECS. In the current preferred embodiment, |
| | this is always 0. |

<job> Syntax

As described above, the job itself contains several sections enclosed within the <job> . . . </job> tags. The first few give vital information describing the job. These are followed by an optional <notify> section, and by the job's <plan>.

| | |
|---|---|
| <priority> | |
| Valid Range: | 1 to 3, with 1 being the highest priority |
| Restrictions: | Required. |
| Function: | Assigns a scheduling priority to the job. Tasks |
| | related to jobs with higher priorities are given precedence |
| | over jobs with lower priorities. |
| <title> | |
| Valid Values: | Any text string, except for the characters ‘<’ and ‘>’ |
| Restrictions: | Required. |
| Function: | Gives a name to the job. |
| <author> | |
| Valid Values: | Any text string, except for the characters ‘<’ and ‘>’ |
| Restrictions: | Required. |
| Function: | Gives an author to the job. |
| <start-time> | |
| Format: | yyyy-mm-dd hh:mm:ss |
| Restrictions: | Optional. The default behavior is to submit the job |
| | immediately. |
| Function: | Indicates the time at which a job should first be |
| | submitted to the ECS's task scheduler. |
| <period> | |
| Range: | Positive integer |
| Restrictions: | Only valid if the <start-time> tag is present. |
| Function: | Indicates the periodicity, in seconds, of a repeating job. |
| | At the end of the period, the job is submitted to the |
| | ECS's task scheduler. |

<notify>

The <notify> section specifies actions that should be taken after the main job has completed. Actions that should be taken when a job successfully completes can simply be included as the last step in the main <plan> of the <job>. Actions that should be taken irregardless of success, or only upon failure, should be included in this section. In one embodiment of the invention, email notifications are the only actions supported by the Planner.

| | |
|---|---|
| <condition> | |
| Valid Values: | always, failure |
| Restrictions: | Required. |
| Function: | Indicates the job completion status which |
| | should trigger the actions |
| | in the <plan> section. |
| <plan> | |
| Valid Values: | See specification of <plan> below |
| Restrictions: | Required. |
| Function: | Designates the actual tasks to be performed. |

<plan> Syntax

The <plan> section encloses one or more tasks, which are executed serially. If a task fails, then execution of the remaining tasks is abandoned. Tasks can consist of individual worker sections, or of multiple sections to be executed in parallel. Because of the recursive nature of tasks, a BNF specification is a fairly exact way to describe them.

task ::=serial_section|parallel_section|worker_task

serial_section ::=‘<serial>’ task* ‘<\serial>’

parallel_section ::=‘<parallel>’ task* ‘<\parallel>’

worker_task::=‘<’ worker_name ‘>’ worker₁₃ parameter* ‘<\’ worker₁₃ name ‘>’

worker_name ::=(‘microsoft’, ‘real’, ‘quicktime’, ‘prefilter’, ‘anymail’, ‘fileman’, ‘1c’ N ‘pp’)

worker₁₃ parameter ::=‘<’ tag ‘>’ value ‘</’ tag ‘>’

The individual tags and values for the worker parameters will be specified further on.

The set of worker names is defined in the database within the workertype table. Therefore, it is very implementation specific and subject to on-site customization.

The Mail Worker

| | |
|---|---|
| Name: | anymail |
| Executable: | anymail.exe |

As its name suggests, the mail worker's mission is the sending of email. In on embodiment of the invention, the ECS supplies the subject and body of the message in the <notify> section.

| | |
|---|---|
| <smtp-server> | |
| Valid Values: | Any valid SMTP server name. |
| Restrictions: | Required. |
| Function: | Designates the SMTP server from which the |
| | email will be sent. |
| <from-address> | |
| Valid Values: | A valid email address. |
| Restrictions: | Required. |
| Function: | Specifies the name of the person who is |
| | sending the email. |
| <to-address> | |
| Valid Values: | One or more valid email addresses, separated by |
| | spaces, tabs, commas, or semicolons. |
| Restrictions: | Required. |
| Function: | Specifies the email recipient(s) |
| <subject> | |
| Valid Values: | Any string. |
| Restrictions: | Required. |
| Function: | Specifies the text to be used on the subject line |
| | of the email. |
| <body> | |
| Valid Values: | Any string. |
| Restrictions: | Required. |
| Function: | Specifies the text to be used as the body of the |
| | email message. |
| <mime-attach> | |
| (Mime Attachments) | |
| Restrictions: | Optional. |

Anymail is capable of including attachments using the MIME standard. Any number of attachments are permitted, although the user should keep in mind that many mail servers will truncate or simply refuse to send very large messages. The mailer has been successfully tested with emails up to 20 MB, but that should be considered the exception rather than the rule. Also remember that the process of attaching a file will increase its size, as it is base-64 encoded to turn it into printable text. Plan on about 26% increase in message size.

| | |
|---|---|
| <compress> | |
| Restrictions: | Optional. Must be paired with <content- |
| | type> application/x-gzip</content-type>. |
| Valid Values: | A valid file or directory path. The path |
| | specification can include wildcards and environment- |
| | variable macros delimited with percent signs |
| | (e.g., % BLUERELEASE %). The environment variable |
| | expansion is of course dependent upon the value of that |
| | variable on the machine where Anymail is running. |
| Function: | Indicates the file or files that should be compressed using |
| | tar/gzip into a single attachment named in the |
| | <file-name>tag. |
| <file-name> | |
| Restrictions: | Required. |
| Valid Values: | A valid file path. The path specification can include |
| | environment variable macros delimited with percent signs |
| | (e.g., % BLUERELEASE %). The environment variable |
| | expansion is of course dependent upon the value of that |
| | variable on the machine where Anymail is running. |
| Function: | Indicates the name of the file that is to be attached. If the |
| | <compress> tag is present, this is the target file |
| | name for the compression. |
| <content-type> | |
| Restrictions: | Required. |
| Valid Values: | Any valid MIME format specification, such as the |
| | following “text/plain; charset = us-ascii” or “application/ |
| | x-gzip”. |
| Function: | Indicates the format of the attached file. This text is |
| | actually inserted in the attachment as an indicator to the |
| | receiving mail application. |

Anymail Example

The example in Listing E sends an email with four attachments, two of which are compressed.

```
<anymail>
  <smtp-server>smtp.example.com</smtp-server>
  <from-address>sender@example.com</from-address>
  <to-address>receiver@example.com</to-address>
  <subject>Server Logs</subject>
  <body>
Attached are your log files.
Best regards,
J. Jones.
  </body>
  <mime-attach>
    <compress>%BLUERELEASE%/logs</compress>
    <file-name>foo.tar.gz</file-name>
    <content-type>application/x-gzip</content-type>
  </mime-attach>
  <mime-attach>
    <compress>%BLUERELEASE%/frogs</compress>
    <file-name>bar.tar.gz</file-name>
    <content-type>application/x-gzip</content-type>
  </mime-attach>
  <mime-attach>
    <file-name>%BLUERELEASE%\apps\AnyMail\exmp.xml
    </file-name>
    <content-type>text/plain; charset=us-ascii</content-type>
  </mime-attach>
  <mime-attach>
    <file-name>%BLUERELEASE%\apps\AnyMail\barfoo.xml</file-
name>
    <content-type>text/plain; charaet=us-ascii</content-type>
  </mime-attach>
</anymail>
```

Listing E

The File Manager

| | |
|---|---|
| Name: | fileman |
| Executable: | fileman.exe |

The file manager performs a number of file-related tasks, such as FTP transfers and file renaming.

TABLE 2
File Manager Commands

| <command> | | |
|---|---|---|
| Valid Values: | | “rename-file”, “delete-file”, “get-file”, “put-file” |
| Restrictions: | | Required. |
| Function: | | Designates the action that the file manager will |
| | | perform. Table 2 summarizes the options. |
| | Command | Description |
| | rename-file | Renames or moves a single local file. |
| | delete-file | Deletes one or more local files. |
| | get-file | Retrieves a single remote file via FTP. |
| | put-file | Copies one or more local files to a remote FTP |
| | | site. |

TABLE 3
File Manager Command Options

| <src-name> | | | |
|---|---|---|---|
| (Source File | | | |
| Name) | | | |
| Valid | A valid file path. With some tags, the path specification | | |
| Values: | can include environment variable macros delimited with | | |
| | percent signs (e.g., % BLUERELEASE %), and/or | | |
| | wildcards. The environment variable expansion is of | | |
| | course dependent upon the value of that variable on the | | |
| | machine where Anymail is running. | | |
| Restrictions: | Required. May occur more than once when combined | | |
| | with some commands. | | |
| Function: | Designates the file or files to which the command should | | |
| | be applied. Table 3 summarizes the options with various | | |
| | commands. | | |
| | | | Occur |
| | En- | | Multiple |
| Command | vironment Variable Expansion | Wildcards | Times |
| rename-file | No | no | no |
| delete-file | Yes | yes | yes |
| get-file | No | no | no |
| put-file | Yes | yes | yes |

| | |
|---|---|
| <dst-name> | |
| (Destination | |
| File Name) | |
| Valid Values: | A full file path or directory, rooted at/. With the |
| | put-file command, any missing components of the path |
| | will be created. |
| Restrictions: | Required for all but the delete-file command. |
| Function: | Designates the location and name of the destination |
| | file. For put-file, the destination must be a directory |
| | when multiple source files - through use of a pattern or |
| | multiple src-name tags - are specified. |
| <newer-than> | |
| (File Age | |
| Upper Limit) | |
| Format: | dd:hh:mm |
| Restrictions: | Not valid with get-file or rename-file. |
| Function: | Specifies a upper limit on the age of the source files. |
| | Used to limit the files selected through use of |
| | wildcards. Can be used in combination with <older- |
| | than> to restrict file ages to a range. |
| <older-than> | |
| (File Age | |
| Lower Limit) | |
| Format: | dd:hh:mm |
| Restrictions: | Not valid with get-file or rename-file. |
| Function: | Specifies an lower limit on the age of the source files. |
| | Used to limit the files selected through use of |
| | wildcards. Can be used in combination with <newer- |
| | than> to restrict file ages to a range. |
| <dst-server> | |
| (Destination | |
| Server) | |
| Valid Values: | A valid host-name. |
| Restrictions: | Required with put-file or get-file. |
| Function: | Designates the remote host for an FTP command. |
| <user-name> | |
| Valid Values: | A valid username for the remote host identified |
| | in <dst-server>. |
| Restrictions: | Required with put-file or get-file. |
| Function: | Designates the username to be used to login to |
| | the remote host for an FTP command. |
| <user- | |
| password> | |
| Valid Values: | A valid password for the username on the remote host |
| | identified in <dst-server>. |
| Restrictions: | Required with put-file or get-file. |
| Function: | Designates the password to be used to login to the remote |
| | host for an FTP command. |

Fileman Examples

The command in listing F will FTP all log files to the specified directory on a remote server.

```
<fileman>
  <command>put-file</command>
  <src-name>%BLUERELEASE%/logs/*.log</src-name>
  <dst-name>/home/guest/logs</dst-name>
  <dst-server>dst-example</dst-server>
  <user-name>guest</user-name>
  <user-password>guest</user-password>
</fileman>
```

Listing F

The command in Listing G will transfer log files from the standard log file directory as well as a back directory to a remote server. It uses the <newer-than> tag to select files that from the last 10 days only.

```
<fileman>
  <command>put-file</command>
  <src-name>%BLUERELEASE%/logs/*.log</src-name>
  <src-name>%BLUERELEASE%/logs/back/*.log</src-name>
  <dst-name>/home/guest/logs</dst-name>
  <dat-server>dst-example</dst-server>
  <user-name>guest</user-name>
  <user-password>guest</user-password>
  <newer-than>10:0:0</newer-than>
</fileman>
```

Listing G

The command in Listing H deletes all log files and backup log files (i.e., in the backup subdirectory) that are older than 7 days.

```
<fileman>
  <command>delete-file</command>
  <src-name>%BLUERELEASE%/logs/*.log</src-name>
  <src-name>%BLUERELEASE%/logs/backup/*.log</src-name>
  <older-than>7:0:0</older-than>
</fileman>
```

Listing H

The Preprocessor

Name: prefilter, or 1c1pp, 1c2 pp, etc. Each live-capture worker must have a unique name.

Executable: prefilter.exe

The preprocessor converts various video formats—including live capture—to .avi files. It is capable of performing a variety of filters and enhancements at the same time.

All preprocessor parameters are enclosed with a <preprocessor> section. A typical preprocessor job would take the form shown in Listing I:

<prefilter>
<preprocess>
. . . .preprocessing parameters . . .
</preprocess>
<prefilter>

Listing I

| | |
|---|---|
| <input-file> | |
| Valid Values: | File name of an existing file. |
| Restrictions: | Required. |
| Function: | Designates the input file for preprocessing, without a path. For live capture, |
| | this value should be “SDI”. |
| <input-directory> | |
| Valid Values: | A full directory path, such d:\media. |
| Restrictions: | Required. |
| Function: | Designates the directory where the input file is located. In the user interface, |
| | this is the “media” directory. |
| <output-file> | |
| Valid Values: | A valid file name. |
| Restrictions: | Required. |
| Function: | Designates the name of the preprocessed file. |
| <output-directory> | |
| Valid Values: | A full directory path. |
| Restrictions: | Required. |
| Function: | Designates the directory where the preprocessed file should be written. This |
| | directory must be accessible by the encoders. |
| <skip> | |
| Valid Values: | yes, n |
| Function: | This tag indicates that preprocessing should be skipped. In this case, an |
| | output file is still created, and it is reformatted to .avi, if necessary, to |
| | provide the proper input format for the encoders. |
| <trigger> | |

<start>

<type>

| | |
|---|---|
| Valid Values: | DTMF, TIME, NOW, IP, TIMECODE |

| | |
|---|---|
| <comm-port> | |
| Min/Default/Max: | 1/1/4 |
| Restrictions: | This parameter is only valid with a <type>DTMF</type>. |
| <duration> | |
| Min/Default/Max: | 0/[none]/no limit |
| Restrictions: | This parameter is only valid with a <type>NOW<type>. |
| Function: | Indicates the length of time that the live capture should run. In a |
| | recent embodiment, this parameter has been removed and the NOW |
| | trigger causes the capture to start immediately. |
| <baud-rate> | |
| Min/Default/Max: | 2400/9600/19200 |
| Restrictions: | This parameter is only valid with a <type>DTMF<type>. |
| <dtmf> | |
| Valid Values: | A valid DTMF tone of the form 999#, where “9” is any digit. |
| Restrictions: | This parameter is only valid with a <type>DTMF<type>. |
| <time> | |
| Valid Values: | A valid time in the format hh:mm:ss. |
| Restrictions: | This parameter is only valid with a <type>TIME<type>. |
| <date> | |
| Valid Values: | A valid date in the format mm/dd/yyyy. |
| Restrictions: | This parameter is only valid with a <type>TIME<type>. |
| <port> | |
| Min/Default/Max: | 1/1/65535 |
| Restrictions: | This parameter is only valid with a <type>IP<type>. |
| <timecode> | |
| Valid Values: | A valid timecode in the format hh:mm:ss:ff. |
| Restrictions: | This parameter is only valid with a <type>TIMECODE<type>. |

<stop>

| | |
|---|---|
| <type> | |
| Valid Values: | DTMF, TIME, NOW, IP, TIMECODE (in a recent embodiment, |
| | the NOW trigger is replaced by DURATION.) |
| <comm-port> | |
| Min/Default/Max: | 1/1/4 |
| Restrictions: | This parameter is only valid with <type>DTMF</type>. |
| <duration> | |
| Min/Default/Max: | 0/[none]/no limit |
| Restrictions: | This parameter is only valid with a <type>NOW</type> or |
| | <type>DURATION</type> |
| Function: | Indicates the length of time that the live capture should run. |
| <baud-rate> | |
| Min/Default/Max: | 2400/9600/19200 |
| Restrictions: | This parameter is only valid with a <type>DTMF<type>. |
| <dtmf> | |
| Valid Values: | A valid DTMF tone of the form 999*, where “9” is any digit. |
| Restrictions: | This parameter is only valid with a <type>DTMF<type>. |
| <time> | |
| Valid Values: | A valid time in the format hh:mm:ss. |
| Restrictions: | This parameter is only valid with a <type>TIME<type>. |
| <date> | |
| Valid Values: | A valid date in the format mm/dd/yyyy. |
| Restrictions: | This parameter is only valid with a <type>TIME<type>. |
| <port> | |
| Min/Default/Max: | 1/1/65535 |
| Restrictions: | This parameter is only valid with a <type>IP<type>. |
| <timecode> | |
| Valid Values: | A valid timecode in the format hh:mm:ss:ff. |
| Restrictions: | This parameter is only valid with a <type>TIMECODE<type>. |

<capture>

| | |
|---|---|
| <video-mode> | |
| Valid Values: | ntsc, pal |
| <channels> | |
| Valid Values: | mono, stereo |

| | |
|---|---|
| <version> | |
| Valid Values: | 1.0 |
| <name> | |
| Valid Values: | basic |

<video>

<destination>

The upper size limit (<width> and <height>) is uncertain: it depends on the memory required to support other preprocessing settings (like temporal smoothing). The inventors have successfully output frames at PAL dimensions (720×576).

| | |
|---|---|
| <width> | |
| Min/Default/Max: | 0/[none]/720 |
| Restrictions: | The width must be a multiple of 8 pixels. The .avi file writer of |
| | the preferred embodiment platform imposes this restriction. There |
| | are no such restrictions on height. |
| Function: | The width of the output stream in pixels. |
| <height> | |
| Min/Default/Max: | 0/[none]/576 |
| Function: | The height of the output stream in pixels. |
| <fps> | |
| (Output Rate) | |
| Min/Default/Max: | 1/[none]/100 |
| Restrictions: | This must be less than or equal to the input rate in seconds. |
| | Currently, this must be an integer. It may be generalized into a |
| | floating-point quantity. |
| Function: | The output frame rate in seconds. The preprocessor will create |
| | this rate by appropriately sampling the input stream (see |
| | “Temporal Smoothing” for more detail). |

<temporal-smoothing>

| | |
|---|---|
| <amount> | |
| Min/Default/Max: | 1/1/6 |
| Function: | This specifies the number of input frames to average when |
| | constructing an output frame, regardless of the input or output |
| | frame rates. The unit of measurement is always frames, where a |
| | frame may contain two fields, or may simply be a full frame. |
| Restrictions: | Large values with large formats make a large demand for BlueICE |
| | memory. |
| Examples: | With fields, a value of 2 will average the data from 4 fields, unless |
| | single-field mode is on, in which case only 2 fields will contribute. |
| | In both cases 2 frames are involved. If the material is not field- |
| | based, a value of 2 will average 2 frames. |

| | |
|---|---|
| <single-field> | |
| Valid Values: | on, off |
| Function: | This specifies whether the system will use all the fields, or simply |
| | every upper field. Single Field Mode saves considerable time (for |
| | certain formats) by halving the decode time. |

<crop>

This section specifies a cropping of the input source material. The units are always pixels of the input, and the values represent the number of rows or columns that are “cut-off” the image. These rows and columns are discarded. The material is rescaled, so that the uncropped portion fits the output format. Cropping can therefore stretch the image in either the x- or y-direction.

| | |
|---|---|
| <left> | |
| Min/Default/Max: | 0/0/<image width − 1> |
| <right> | |
| Min/Default/Max: | 0/0/<image width − 1> |
| <top> | |
| Min/Default/Max: | 0/0/<image height − 8> |
| <bottom> | |
| Min/Default/Max: | 0/0/<image height − 8> |

| | |
|---|---|
| <inverse-telecine> | |
| Valid Values: | yes, no |
| Restrictions: | Ignored in one embodiment of the invention. |
| <blur> | |
| Valid Values: | custom, smart |
| Function: | Defines the type of blurring to use. |
| <custom-blur> | |
| Min/Default/Max: | 0.0/0.0/8.0 |
| Restrictions: | Only valid in combination with <blur>custom</blur>. The vertical |
| | part of the blur kernel size is limited to approximately 3 BlueICE node |
| | widths. It fails gracefully, limiting the blur kernel to a rectangle whose |
| | width is 3/8 of the image height (much more blurring than anyone |
| | would want). |
| Function: | This specifies the amount of blurring according to the Gaussian |
| | Standard Deviation in thousandths of the image width. Blurring |
| | degrades the image but provides for better compression ratios. |
| Example: | A value of 3.0 on a 320 × 240 output format blurs with a standard |
| | deviation of about 1 pixel. Typical blurs are in the 0-10 range. A |
| | small blur, visible on a large format, may have an imperceptible effect |
| | on a small format. |
| <noise-reduction> | |
| <brightness> | |
| Min/Default/Max: | 0/100/200 |
| Function: | Adjusts the brightness of the output image, as a percent of normal. |
| | The adjustments are made in RGB space, with R, G and B treated the |
| | same way. |
| <contrast> | |
| Min/Default/Max: | 0/100/200 |
| Function: | Adjusts the contrast of the output image, as a percent of normal. The |
| | adjustments are made in RGB space, with R, G and B treated the same |
| | way. |
| <hue> | |
| Min/Default/Max: | −360/0/360 |
| Function: | Adjusts the hue of the output image. The adjustments are made in |
| | HLS space. Hue is in degrees around the color wheel in R-G-B order. |
| | A positive hue value pushes greens toward blue; a negative value |
| | pushes greens toward red. A value of 360 degrees has no effect on the |
| | colors. |
| <saturation> | |
| Min/Default/Max: | 0/100/200 |
| Function: | Adjusts the saturation of the output image. The adjustments are made |
| | in HLS space. Saturation is specified as a percent, with 100% making |
| | no change. |

<black-point>

Luminance values less than <point> (out of a 0-255 range) are reduced to 0. Luminance values greater than <point>+<transition> remain unchanged. In between, in the transition region, the luminance change ramps linearly from 0 to <point>+<transition>.

| <point> | |
|---|---|
| Min/Default/Max: | 0/0/255 |
| <transition> | |
| Min/Default/Max: | 1/1/10 |

<white-point>

Luminance values greater than <point> (out of a 0-255 range) are increased to 255. Luminance values less than <point>−<transition> remain unchanged. In between, in the transition region, the luminance change ramps linearly from <point>−<transition> to 255.

| <point> | |
|---|---|
| Min/Default/Max: | 0/255/255 |
| <transition> | |
| Min/Default/Max: | 1/1/10 |

<gamma>

The Gamma value changes the luminance of mid-range colors, leaving the black and white ends of the gray-value range unchanged. The mapping is applied in RGB space, and each color channel c independently receives the gamma correction. Considering c to be normalized (range 0.0 to 1.0), the transform raises c to the power 1/gamma.

Min/Default/Max: 0.2/1.0/5.0

<watermark>

Specification of a watermark is optional. The file is resized to <width>×<height> and placed on the input stream with this size. The watermark upper left corner coincides with the input stream upper left corner by default, but is translated by <x><y> in the coordinates of the input image. The watermark is then placed on the input stream in this position. There are two modes: “composited” and “luminance”. The watermark strength, normally 100, can be varied to make the watermark more or less pronounced.

The watermark placement on the input stream is only conceptual. The code actually resizes the watermark appropriately and places it on the output stream. This is significant because the watermark is unaffected by any of the other preprocessing controls (except fade). To change the contrast of the watermark, this work must be done ahead of time to the watermark file.

Fancy watermarks that include transparency variations may be make with Adobe® Photoshop®, Adobe After Effects®, or a similar program and stored in .psd format that supports alpha.

The value of “luminance mode” is that the image is altered, never covered. Great looking luminance watermarks can be make with the “emboss” feature of Photoshop or other graphics programs. Typical embossed images are mostly gray, and show the derivative of the image.

<source-location>

Valid Values: A full path to a watermark source file on the host system. Valid file extensions are .psd, .tga, .pct, and .bmp.

| | |
|---|---|
| Restrictions: | Required. |

| | |
|---|---|
| <width> | |
| Min/Default/Max: | 0/[none]/(unknown upper limit) |
| <height> | |
| Min/Default/Max: | 0/[none]/(unknown upper limit) |
| <x> | |
| Min/Default/Max: | −756/0/756 |
| <x-origin> | |
| Valid Values: | left, right |
| <y> | |
| Min/Default/Max: | −578/0/578 |
| <y-origin> | |
| Valid Values: | top, bottom |
| <mode> | |
| Valid Values: | composited, luminance |
| Function: | In “composited” mode, the compositing equation is used to blend |
| | the watermark (including alpha channel) with the image. For |
| | images with full alpha (255) the watermark is completely opaque |
| | and covers the image. Pixels with zero alpha are completely |
| | transparent, allowing the underlying image to be seen. |
| | Intermediate values produce a semi-transparent watermark. The |
| | <strength> parameter modulates the alpha channel. In particular, |
| | opaque watermarks made without alpha can be adjusted to be |
| | partially transparent with this control. |
| | “Luminance” mode uses the watermark file to control the |
| | brightness of the image. A gray pixel in the watermark file does |
| | nothing in luminance mode. Brighter watermark pixels increase |
| | the brightness of the image. Darker watermark pixels decrease the |
| | brightness of the image. The <strength> parameter modulates |
| | this action to globally amplify or attenuate the brightness changes. |
| | If the watermark has an alpha channel, this also acts to attenuate |
| | the strength of the brightness changes pixel-by-pixel. The |
| | brightness changes are made on a channel-by-channel basis, using |
| | the corresponding color channel in the watermark. Therefore, |
| | colors in the watermark will show up in the image (making the |
| | term “luminance mode” a bit of a misnomer). |
| <strength> | |
| Min/Default/Max: | 0/100/200 |

| | |
|---|---|
| <fade-in> | |
| Min/Default/Max: | 0.0/0.0/10.0 |
| Restriction: | The sum of <fade-in> and <fade-out> should not exceed the length of |
| | the clip. Fading is disallowed during DV capture. |
| Function: | Fade-in specifies the amount of time (in seconds) during which the |
| | stream fades up from black to full brightness at the beginning of the |
| | stream. Fading is the last operation applied to the stream and affects |
| | everything, including the watermark. Fading is always a linear change |
| | in image brightness with time. |
| <fade-out> | |
| Min/Default/Max: | 0.0/0.0/10.0 |
| Restriction: | The sum of <fade-in> and <fade-out> should not exceed the length of |
| | the clip. Fading is disallowed during DV capture. |
| Function: | Fade-out specifies the amount of time (in seconds) during which the |
| | stream fades out to black to full brightness at the end of the stream. |
| | Fading is the last operation applied to the stream and affects |
| | everything, including the watermark. Fading is always a linear change |
| | in image brightness with time. |

<audio>

| | |
|---|---|
| <sample-rate> | |
| Min/Default/Max: | 8000/[none]/48000 |
| <channels> | |
| Valid Values: | mono, stereo |
| <low-pass> | |
| Min/Default/Max: | 0.0/0.0/48000.0 |
| <high-pass> | |
| Min/Default/Max: | 0.0/0.0/48000.0 |
| Restrictions: | Not supported in one embodiment of the invention. |
| <volume> | |

| | |
|---|---|
| <type> | |
| Valid Values: | none, adjust, normalize |
| <adjust> | |
| Min/Default/Max: | 0.0/50.0/200.0 |
| Restrictions: | Only valid with <type>adjust</type>. |
| <normalize> | |
| Min/Default/Max: | 0.0/50.0/100.0 |
| Restrictions: | Only valid with <type>normalize</type>. |

<compressor>

| | |
|---|---|
| <threshold> | |
| Min/Default/Max: | −40.0/6.0/6.0 |
| <ratio> | |
| Min/Default/Max: | 1.0/20.0/20.0 |

| | |
|---|---|
| <fade-in> | |
| Min/Default/Max: | 0.0/0.0/10.0 |
| Restriction: | The sum of <fade-in> and <fade-out> should not exceed the length of |
| | the clip. Fading is disallowed during DV capture. |
| Function: | Fade-in specifies the amount of time (in seconds) during which the |
| | stream fades up from silence to full sound at the beginning of the |
| | stream. Fading is always a linear change in volume with time. |
| <fade-out> | |
| Min/Default/Max: | 0.0/0.0/10.0 |
| Restriction: | The sum of <fade-in> and <fade-out> should not exceed the length of |
| | the clip. Fading is disallowed during DV capture. |
| Function: | Fade-out specifies the amount of time (in seconds) during which the |
| | stream fades out to silence to full volume at the end of the stream. |
| | Fading is always a linear change in volume with time. |

Encoder Common Parameters

<meta-data>

The meta-data section contains information that describes the clip that is being encoded. These parameters (minus the <version> tag) are encoded into the resulting clip and can be used for indexing, retrieval, or information purposes.

| | |
|---|---|
| <version> | |
| Valid Values: | “1.0” until additional versions are released. |
| Restrictions: | Required. |
| Function: | The major and minor version (e.g., 1.0) of the meta-data section |
| | format. In practice, this parameter is ignored by the encoder. |
| <title> | |
| Valid Values: | Text string, without ‘<’ or ‘>’ characters. |
| Restrictions: | Required. |
| Function: | A short descriptive title for the clip. If this field is missing, the |
| | encoder generates a warning message. |
| <description> | |
| Valid Values: | Text string, without ‘<’ or ‘>’ characters. |
| Restrictions: | Optional. |
| Function: | A description of the clip. |
| <copyright> | |
| Valid Values: | Text string, without ‘<’ or ‘>’ characters. |
| Restrictions: | Optional. |
| Function: | Clip copyright. If this field is missing, the encoder generates a |
| | warning message. |
| <author> | |
| Valid Values: | Text string, without ‘<’ or ‘>’ characters. |
| Restrictions: | Required. |
| Function: | Designates the author of the clip. In one embodiment of the |
| | invention, the GUI defaults this parameter to the username of the |
| | job's submitter. If this field is missing, the Microsoft and Real |
| | encoders generate a warning message. |
| <rating> | |
| Valid Values: | “General Audience”, “Parental Guidance”, “Adult Supervision”, |
| | “Adult”, “G”, “PG”, “R”, “X” |
| Restrictions: | Optional. |
| Function: | Designates the rating of the clip. In one embodiment of the |
| | invention, submit.plx sets this parameter to “General Audience”. |

<monitor-win> (Show Monitor Window)

| | |
|---|---|
| Valid Values: | yes, no |
| Restrictions: | Optional. |
| Function: | Indicates whether or not the encoder should display a window that shows |
| | the encoding in process. For maximum efficiency, this parameter should |
| | be set to no. |

<network-congestion>

The network congestion section contains hints for ways that the encoders can react to network congestion.

| | |
|---|---|
| <loss-protection> | |
| Valid Values: | yes, no |
| Function: | A value of yes indicates that extra |
| | information should be added to the |
| | stream in order to make it more fault |
| | tolerate. |
| <prefer-audio-over-video> | |
| Valid Values: | yes, no |
| Function: | A value of yes indicates that video should |
| | degrade before audio does. |

The Microsoft Encoder

| | |
|---|---|
| Name: | microsoft |
| Executable: | msencode.exe |

The Microsoft Encoder converts .avi files into streaming files in the Microsoft-specific formats.

| | |
|---|---|
| <src> (Source File) | |
| Valid Values: | File name of an existing file. |
| Restrictions: | Required. |
| Function: | Designates the input file for encoding. This |
| | should be the output file from the |
| | preprocessor. |
| <dst> (Destination File) | |
| Valid Values: | File name for the output file. |
| Restrictions: | Required. |
| Function: | Designates the output file for encoding. If this |
| | file already exists, it will be overwritten. |
| <encapsulated> | |
| Valid Values: | true, false |
| Function: | Indicates whether the output file uses |
| | Intellistream. If the MML indicates multiple |
| | targets and <encapsulated> is false, an |
| | Intellistream is used and a warning is |
| | generated. |
| <downloadable> | |
| Valid Values: | yes, no |
| Function: | Indicates whether a streaming file can be |
| | downloaded and played in its entirety. |

<recordable>

his tag is not valid for Microsoft. The one embodiment of the invention GUI passes a value for it into the Planner, but the encoder ignores it.

| | |
|---|---|
| <seekable> | |
| Valid Values: | yes, no |
| Function: | Indicates whether the user can skip through the |
| | stream, rather than playing it linearly. |
| <max-keyframe-spacing> | |
| Min/Default/Max: | 0.0/8.0/200.0 |
| Function: | Designates that a keyframe will occur at least |
| | every <max-keyframe-spacing> seconds. A |
| | value of 0 indicates natural keyframes. |
| <video-quality> | |
| Min/Default/Max: | 0/0/100 |
| Restrictions: | Optional. |
| Function: | This tag is used to control the trade-off between |
| | spatial image quality and the number of frames. |
| | 0 refers to the smoothest motion (highest |
| | number of frames) and 100 to the sharpest |
| | picture (least number of frames). |

<targets

The target section is used to specify the settings for a single stream. The Microsoft Encoder is capable of producing up to five separate streams. The audio portions for each target must be identical.

| | |
|---|---|
| <name> | |
| Valid Values: | 14.4k, 28.8k, 56k, ISDN, Dual ISDN, xDSL\Cable |
| | Modem, xDSL.384\Cable Modem, xDSL.512\Cable |
| | Modem, T1, LAN |
| Restrictions: | Required. |

<video>

The video section contains parameters that control the production of the video portion of the stream. This section is optional: if it is omitted, then the resulting stream is audio-only.

| | |
|---|---|
| <codec> | |
| Valid Values: | MPEG4V3, Windows Media Video V7, Windows |
| | Media Screen V7 |
| Restrictions: | Each codec has specific combinations of valid bit-rate |
| | and maximum FPS. |
| Function: | Specifies the encoding format to be used. |
| <bit-rate> | |
| Min/Default/Max: | 10.0/[none]/5000.0 |
| Restrictions: | Required. |
| Function: | Indicates the number of kbits per second at which the |
| | stream should encode. |
| <max-fps> | |
| Min/Default/Max: | 4/5/30 |
| Function: | Specifies the maximum frames per second that the |
| | encoder will encode. |
| <width> | |
| Min/Default/Max: | 80/[none]/640 |
| Restrictions: | Required. Must be divisible by 8. Must be identical to |
| | the width in the input file, and therefore identical for |
| | each defined target. |
| Function: | Width of each frame, in pixels. |
| <height> | |
| Min/Default/Max: | 60/[none]/480 |
| Restrictions: | Required. Must be identical to the height in the input |
| | file, and therefore identical for each defined target. |
| Function: | Height of each frame, in pixels. |

<audio>

The audio section contains parameters that control the production of the audio portion of the stream. This section is optional: if it is omitted, then the resulting stream is video-only.

| | |
|---|---|
| <codec> | |
| Valid Values: | Windows Media Audio V7, Windows Media Audio |
| | V2, ACELP.net |
| Function: | Indicates the audio format to use for encoding. |
| <bit-rate> | |
| Min/Default/Max: | 4.0/8.0/160.0 |
| Function: | Indicates the number of kbits per second at which the |
| | stream should encode. |
| <channels> | |
| Valid Values: | mono, stereo |
| Function: | Indicates the number of audio channels for the |
| | resulting stream. A value of stereo is only valid if the |
| | incoming file is also in stereo. |
| <sample-rate> | |
| Min/Default/Max: | 4.0/8.0/44.1 |
| Restrictions: | Required. |
| Function: | The sample rate of the audio file output in kHz. |

The Real Encoder

| | |
|---|---|
| Name: | real |
| Executable: | rnencode.exe |

The Real Encoder converts .avi files into streaming files in the Real-specific formats.

| | |
|---|---|
| <src> (Source File) | |
| Valid Values: | File name of an existing file. |
| Restrictions: | Required. |
| Function: | Designates the input file for encoding. This |
| | should be the output file from the |
| | preprocessor. |
| <dst> (Destination File) | |
| Valid Values: | File name for the output file. |
| Restrictions: | Required. |
| Function: | Designates the output file for encoding. If this |
| | file already exists, it will be overwritten. |
| <encapsulated> | |
| Valid Values: | true, false |
| Restrictions: | Optional |
| Function: | Indicates whether the output file uses |
| | SureStream. |
| <downloadable> | |
| Valid Values: | yes, no |
| Restrictions: | Optional |
| Function: | Indicates whether a streaming file can be |
| | downloaded and played in its entirety. |
| <recordable> | |
| Valid Values: | yes, no |
| Restrictions: | Optional |
| Function: | Indicates whether the stream can be saved to |
| | disk. |
| <seekable> | |

This tag is not valid for Real. The GUI in one embodiment of the invention passes a value for it into the Planner, but the encoder ignores it.

| | |
|---|---|
| <max-keyframe-spacing> | |
| Min/Default/Max: | 0.0/8.0/200.0 |
| Function: | Designates that a keyframe will occur at least |
| | every <max-keyframe-spacing>seconds. A |
| | value of 0 indicates natural keyframes. |
| <video-quality> | |
| Valid Values: | normal, smooth motion, sharp image, slide |
| | show |
| Function: | This tag is used to control the trade-off between |
| | spatial image quality and the number of frames. |
| | How does this relate to the MS <video- |
| | quality>measurement |
| <encode-mode> | |
| Valid Values: | VBR, CBR |
| Function: | Indicates constant (CBR) or variable bit- |
| | rate (VBR) encoding. |
| <encode-passes> | |
| Min/Default/Max: | 1/1/2 |
| Function: | A value of 2 enables multiple pass encoding for |
| | better quality compression. |
| <audio-type> | |
| Valid Values: | voice, voice with music, music, stereo music |
| <output-server> | |
| Restrictions: | This section is optional. |
| <server-name> | |
| Function: | Identify the server |
| <stream-name> | |
| Function: | Identify the stream |
| <server-port> | |
| Min/Default/Max: | 0/[none]/65536 |
| <user-name> | |
| Function: | Identify the user |
| <user-password> | |
| Function: | Store the password |

<target>

The target section is used to specify the settings for a single stream. The Microsoft Encoder is capable of producing up to five separate streams. In one embodiment of the invention, the audio portions for each target must be identical.

| | |
|---|---|
| <name> | |
| Valid Values: | 14.4k, 28.8k, 56k, ISDN, Dual ISDN, xDSL\Cable |
| | Modem, |
| | xDSL.384\Cable Modem, xDSL.512\Cable Modem, |
| | T1, LAN |
| Restrictions: | Required. |

<video>

The video section contains parameters related to the video component of a target bit-rate. This section is optional: if it is omitted, then the resulting stream is audio-only.

| | |
|---|---|
| <codec> | |
| Valid Values: | RealVideo 8.0, RealVideo G2, RealVideo G2 |
| | with SVT |
| Restrictions: | Each codec has specific combinations of valid bit- |
| | rate and maximum FPS. |
| Function: | Indicates the encoding format to be used for the video |
| | portion. |
| <bit-rate> | |
| Min/Default/Max: | 10.0/[none]/5000.0 |
| Restrictions: | Required. |
| Function: | Indicates the number of kbits per second at which |
| | the video portion should encode. |
| <max-fps> | |
| Min/Default/Max: | 4/[none]/30 |
| Restrictions: | Optional. |
| Function: | Specifies the maximum frames per second that |
| | the encoder will encode. |
| <width> | |
| Min/Default/Max: | 80/[none]/640 |
| Restrictions: | Required. Must be divisible by 8. Must be identical |
| | to the width in the input file, and therefore identical |
| | for each defined target. |
| Function: | Width of each frame, in pixels. |
| <height> | |
| Min/Default/Max: | 60/[none]/480 |
| Restrictions: | Required. Must be identical to the height in the |
| | input file, and therefore identical for each |
| | defined target. |
| Function: | Height of each frame, in pixels. |

<audio>

The audio section contains parameters that control the production of the audio portion of the stream. This section is optional: if it is omitted, then the resulting stream is video-only.

| | |
|---|---|
| <codec> | |
| Valid Values: | G2 |
| Function: | Specifies the format for the audio portion. |
| | In one embodiment of the invention, there is only |
| | one supported codec. |
| <bit-rate> | |
| Min/Default/Max: | 4.0/8.0/160.0 |
| Function: | Indicates the number of kbits per second at |
| | which the stream should encode. |
| <channels> | |
| Valid Values: | mono, stereo |
| Function: | Indicates the number of audio channels for the |
| | resulting stream. A value of stereo is only valid if the |
| | incoming file is also in stereo. |
| <sample-rate> | |
| Min/Default/Max: | 4.0/8.0/44.1 |
| Restrictions: | Required. |
| Function: | The sample rate of the audio file output in kHz. |

The Quicktime Encoder

| | |
|---|---|
| Name: | quicktime |
| Executable: | qtencode.exe |

The Quicktime Encoder converts avi files into streaming files in the Quicktime-specific formats. Unlike the Microsoft and Real Encoders, Quicktime can produce multiple files. It produces one or more stream files, and if<encapsulation> is true, it also produces a reference file. The production of the reference file is a second step in the encoding process.

| | |
|---|---|
| <input-dir> | |
| (Input Directory) | |
| Valid Values: | A full directory path, such as |
| | //localhost/media/ppoutputdir. |
| Restrictions: | Required. |
| Function: | Designates the directory where the input |
| | file is located. This is typically the |
| | preprocessor's output directory. |
| <input-file> | |
| Valid Values: | A simple file name, without a path. |
| Restrictions: | Required, and the file must already exist. |
| Function: | Designates the input file for encoding. |
| | This should be the output file from |
| | the preprocessor. |
| <tmp-dir> | |
| (Temporary Directory) | |
| Valid Values: | A full directory path. |
| Restrictions: | Required. |
| Function: | Designates the directory where Quicktime |
| | may write any temporary working files. |
| <output-dir> | |
| (Output Directory) | |
| Valid Values: | A full directory path. |
| Restrictions: | Required. |
| Function: | Designates the directory where the stream |
| | files should be written. |
| <output-file> | |
| (Output File) | |
| Valid Values: | A valid file name. |
| Restrictions: | Required. |
| Function: | Designates the name of the reference file, |
| | usually in the form of <name>.qt. |
| | The streams are written to files of |
| | the form <name>.<target>.qt. |
| <ref-file-dir> | |
| (Reference File Output | |
| Directory) | |
| Valid Values: | An existing directory. |
| Restrictions: | Required. |
| Function: | Designates the output directory for the |
| | Quicktime reference file. |
| <ref-file-type> | |
| (Reference File Type) | |
| Valid Values: | url, alias. |
| Restrictions: | Optional. |
| <server-base-url> | |
| (Server Base URL) | |
| Valid Values: | A valid URL. |
| Restrictions: | Required if <encapsulation> is true and |
| | <ref-file-type> is url or missing |
| Function: | Designates the URL where the stream |
| | files will be located. Required in order |
| | to encode this location into |
| | the reference file. |
| <encapsulated> | |
| (Generate Reference File) | |
| Valid Values: | true, false |
| Restrictions: | Optional |
| Function: | Indicates whether a reference |
| | file is generated. |
| <downloadable> | |
| Valid Values: | yes, no |
| Restrictions: | Optional |
| Function: | Indicates whether a streaming file can be |
| | downloaded and played in its entirety. |
| <recordable> | |
| Valid Values: | yes, no |
| Restrictions: | Optional |
| Function: | Indicates whether the stream |
| | can be saved to disk. |
| <seekable> | |
| Valid Values: | yes, no |
| Restrictions: | Optional |
| Function: | Indicates whether the user can skip through |
| | the stream, rather than playing it linearly. |
| <auto-play> | |
| Valid Values: | yes, no |
| Restrictions: | Optional |
| Function: | Indicates whether the file should |
| | automatically play once it is loaded. |
| <progressive-download> | |
| Valid Values: | yes, no |
| Restrictions: | Optional |
| <compress-movie-header> | |
| Valid Values: | yes, no |
| Restrictions: | Optional |
| Function: | Indicates whether the Quicktime movie |
| | header should be compressed to save |
| | space. Playback of compressed headers |
| | requires Quicktime 3.0 or higher. |
| <embedded-url> | |
| Valid Values: | A valid URL. |
| Restrictions: | Optional |
| Function: | Specifies a URL that should be displayed |
| | as Quicktime is playing. |

<media>

A media section specifies a maximum target bit-rate and its associated parameters. The Quicktime encoder supports up to nine separate targets in a stream.

| | |
|---|---|
| <target> | |
| Valid Values: | 14.4k, 28.8k, 56k, Dual-ISDN, T1, LAN |
| Restrictions: | Required. A warning is generated if the sum of |
| | the video and audio bit-rates specified in the media |
| | section exceeds the total bit-rate associated |
| | the selected target. |
| Function: | Indicates a maximum desired bit-rate. |

<video>

The video section contains parameters related to the video component of a target bit-rate.

| | |
|---|---|
| <bit-rate> | |
| Min/Default/Max: | 5.0/[none]/10,000.0 |
| Restrictions: | Required. |
| Function: | Indicates the number of kbits per second at |
| | which the video portion should encode. |
| <target-fps> | |
| Min/Default/Max: | 1/[none]/30 |
| Restrictions: | Required. |
| Function: | Specifies the desired frames per second that |
| | the encoder will attempt to achieve. |
| <automatic-keyframes> | |
| Valid Values: | yes, no |
| Function: | Indicates whether automatic or fixed |
| | keyframes should be used |
| <max-keyframe-spacing> | |
| Min/Default/Max: | 0.0/0.0/5000.0 |
| Function: | Designates that a keyframe will occur at least |
| | every <max-keyframe-spacing> seconds. |
| | A value of 0 indicates natural keyframes |
| <quality> | |
| Min/Default/Max: | 0/10/100 |
| Function: | This tag is used to control the trade-off between |
| | spatial image quality and the number of frames. |
| | 0 refers to the smoothest motion (highest |
| | number of frames) and 100 to the sharpest |
| | picture (least number of frames). |
| <encode-mode> | |
| Valid Values: | CBR |
| Function: | Indicates constant bit-rate (CBR) encoding. |
| | At some point, variable bit-rate (VBR) |
| | may be an option. |
| <codec> | |

This section specifies the parameters that govern the video compression/decompression.

| | |
|---|---|
| <type> | |
| Valid Values: | Sorenson2 |
| Function: | Indicates whether automatic or fixed keyframes should be |
| | used. |
| <faster-encoding> | |
| Valid Values: | fast, slow |
| Function: | Controls the mode of the Sorenson codec that |
| | increases the encoding speed at the expense of |
| | quality. |
| <frame-dropping> | |
| Valid Values: | yes, no |
| Function: | A value of yes indicates that the encoder may drop |
| | frames if the maximum bit-rate has been exceeded. |
| <data-rate-tracking> | |
| Min/Default/Max: | 0/17/100 |
| Function: | Tells the Sorenson codec how closely to follow the target bit- |
| | rate for each encoded frame. Tracking data rate tightly takes |
| | away some ability of the codec to maintain image quality. |
| | This setting can be dangerous as a high value my prevent a file |
| | from playing in bandwidth-restricted situations due to bit-rate |
| | spikes. |
| <force-block-refresh> | |
| Min/Default/Max: | 0/0/50 |
| Function: | This feature of the Sorenson coded is used to add error |
| | checking codes to the encoded stream to help recovery during |
| | high packet-loss situations. This tag is equivalent to the |
| | <loss-protection> tag, but with a larger valid range. |
| <image-smoothing> | |
| Valid Values: | yes, no |
| Function: | This tag turns on the image de-blocking function of |
| | the Sorenson decoder to reduce low-bit-rate |
| | artifacts. |
| <keyframe-sensitivity> | |
| Min/Default/Max: | 0/50/100 |
| <keyframe-size> | |
| Min/Default/Max: | 0/100/100 |
| Function: | Dictates the percentage of “normal” at which a keyframe will |
| | be created. |
| <width> | |
| Min/Default/Max: | 80/[none]/640 |
| Restrictions: | Required. Must be divisible by 8. Must be identical to the width |
| | in the input file, and therefore identical for each defined target. |
| Function: | Width of each frame, in pixels. |
| <height> | |
| Min/Default/Max: | 60/[none]/480 |
| Restrictions: | Required. Must be identical to the height in the input file, and |
| | therefore identical for each defined target. |
| Function: | Height of each frame, in pixels. |
| <audio> | |
| <bit-rate> | |
| Min/Default/Max: | 4.0/[none]/10000.0 |
| Restrictions: | Required. |
| Function: | Indicates the number of kbits per second at which the stream |
| | should encode. |
| <channels> | |
| Valid Values: | mono, stereo |
| Function: | Indicates the number of audio channels for the resulting stream. A |
| | value of stereo is only valid if the incoming file is also in stereo. |
| <type> | |
| Valid Values: | music, voice |
| Function: | Indicates the type of audio being encoded, which in turn affects the |
| | encoding algorithm used in order to optimize for the given type. |
| <frequency-response> | |
| Min/Default/Max: | 0/5/10 |
| Function: | This tag is used to pick what dynamic range the user wants to |
| | preserve. Valid values are 0 to 10 with 0 the default. 0 means the |
| | least frequency response and 10 means the highest appropriate for |
| | this compression rate. Adding dynamic range needlessly will |
| | result in more artifacts of compression (chirps, ringing, etc.) and |
| | will increase compression time |
| <codec> | |
| <type> | |
| Valid Values: | QDesign2, Qualcomm, IMA4:1 |
| Function: | Specifies the compression/decompression method for the |
| | audio portion. |
| <sample-rate> | |
| Valid Values: | 4, 6, 8,11.025, 16, 22.050, 24, 32, 44.100 |
| Function: | The sample rate of the audio file output in kHz. |
| <attack> | |
| Min/Default/Max: | 0/50/100 |
| Function: | This tag controls the transient response of the codec. Higher |
| | settings allow the codec to respond more quickly to |
| | instantaneous changes in signal energy most often found in |
| | percussive sounds. |
| <spread> | |
| Valid Values: | full, half |
| Function: | This tag selects either full or half-rate encoding. This |
| | overrides the semiautomatic kHz selection based on the |
| | <frequency-response> tag. |
| <rate> | |
| Min/Default/Max: | 0/50/100 |
| Function: | This tag is a measure of the tonal versus noise-like nature of |
| | the input signal. A lower setting will result in clear, but |
| | sometimes metallic audio. A higher setting will result in |
| | warmer, but nosier audio.. |
| <optimize-for-streaming> | |
| Valid Values: | yes, no |
| Function: | This tag selects either full or half-rate encoding. This |
| | overrides the semiautomatic kHz selection based on the |
| | <frequency-response> tag. |

Local Control System (LCS)

The Local Control System (LCS) represents a service access point for a single computer system or server. The LCS provides a number of services upon the computer where it is running. These services are made available to users of the preferred embodiment through the Enterprise Control System (ECS). The services provided by the LCS are operating system services. The LCS is capable of starting, stopping, monitoring, and communicating with workers that take the form of local system processes. It can communicate with these workers via a bound TCP/IP socket pair. Thus it can pass commands and other information to workers and receive their status information in return. The status information from workers can be sent back to the ECS or routed to other locations as required by the configuration or implementation. The semantics of what status information is forwarded and where it is sent reflects merely the current preferred embodiment and is subject to change. The exact protocol and information exchanged between the LCS and workers is covered in a separate section below.

Process creation and management are but a single form of the operating system services that might be exported. Any number of other capabilities could easily be provided. So the LCS is not limited in this respect. As a general rule, however, proper design dictates keeping components as simple as possible. Providing this basic capability, which is in no way tied directly to the task at hand, and then implementing access to other local services and features via workers provides a very simple, flexible and extensible architecture.

The LCS is an internet application. Access to the services it provides is through a TCP/IP socket. The LCS on any given machine is currently available at TCP/IP port number 3500 by convention only. It is not a requirement. It is possible to run multiple instances of the LCS on a single machine. This is useful for debugging and system integration but will probably not be the norm in practice. If multiple instances of the LCS are running on a single host they should be configured to listen on unique port numbers. Thus the LCS should be thought of as the single point of access for services on a given computer.

All LCS service requests are in the form of XML communicated via the TCP/IP connection. Note, that the selection of the TCP/IP protocol was made in light of its ubiquitous nature. Any general mechanism that provides for inter-process communication between distinct computer systems could be used. Also the choice of XML, which is a text-based language, provides general portability and requires no platform or language specific scheme to martial and transmit arguments. However, other markup, encoding or data layout could be used.

ECS/LCS Protocol

In the currently preferred embodiment, the LCS is passive with regard to establishing connections with the ECS. It does not initiate these connections, rather when it begins execution it waits for an ECS to initiate a TCP/IP connection. Once this connection is established it remains open, unless explicitly closed by the ECS, or it is lost through an unexpected program abort, system reboot or serious network error, etc. Note this is an implementation issue rather than an architecture issue. Further, on any given computer platform an LCS runs as a persistent service. Under Microsoft WindowsNT/2000 it is a system service. Under various versions of Unix it runs as a daemon process.

In current embodiments, when an LCS begins execution, it has no configuration or capabilities. Its capabilities must be established via a configuration or reconfiguration message from an ECS. However, local default configurations may be added to the LCS to provide for a set of default services which are always available.

LCS Configuration

When a connection is established between the ECS and the LCS, first thing received by the LCS should be either a configuration message or a reconfiguration message. The XML document tag <1cs-configuration> denotes a configuration message. The XML document tag <1cs-reconfiguration> denotes a reconfiguration message. These have the same structure and differ only by the XML document tag. The structure of this document can be found in Listing 1.

```
<lcs-configuration>
  <lcs-resource-id>99</lcs-resource-id>
  <log-config>0</log-config>
  <resource>
    <id>1</id>
    <name>fileman</name>
    <program>fileman.exe</program>
  </resource>
  <resource>
    <id>2</id>
    <name>prefilter</name>
    <program>prefilter.exe</program>
  </resource>
. . .
</lcs-configuration>
```

Listing 1

There is a C++ class implemented to build, parse and validate this XML document. This class is used in both the LCS and the ECS. As a rule, an<1cs-configuration> message indicates that the LCS should maintain and communicate any pending status information from workers that may have been or still be active when the configuration message is received. An<1cs-reconfiguration> message indicates that the LCS should terminate any active workers and discard all pending status information from those workers.

Upon receiving an<1cs-configuration> message, the LCS discards its old configuration in favor of the new one. It then sends back one resource-status message, to indicate the availability of the resources on that particular system. Availability is determined by whether or not the indicated executable is found in the ‘bin’ sub-directory of the directory indicated by a specified system environment variable. At present only the set of resources found to be available are returned in the resource status message. Their <status> is flagged as ‘ok’. See example XML response document, Listing 2 below. Resources from the configuration, not included in this resource-status message, are assumed off-line or unavailable for execution.

<resource-status>

<status>ok</status>
<resource-id>0</resource-id>
<resource-id>1</resource-id>
<resource-id>2</resource-id>
...

</resource-status>

Listing 2

As previously stated, in the case of the an <1cs-configuration> message, after sending the <resource-status> message, the LCS will then transmit any pending status information for tasks that are still running or may have completed or failed before the ECS connected or reconnected to the LCS. This task status information is in the form of a <notification-message>. See Listing 3 below for an example of a status indicating that a worker failed. The description of notification messages which follows this discussion provides full details.

<notification-message>

<date-time>2001-05-03 21:07:19</date-time>
<computer-name>host</computer-name>
<user-name>J. Jones</user-name>
<task-status>

<failed></failed>

</task-status>
<resource-id>1</resource-id>
<task-id>42</task-id>

</notification-message>

Listing 3

In the case of an<1cs-reconfiguration> command, the LCS accepts the new configuration, and it sends back the <resource-status> message. Then it terminates all active jobs, and deletes all pending notification messages. Thus a reconfiguration messages acts to clear away any state from the LCS, including currently active tasks. The distinction between these two commands provides for a mechanism for the ECS to come and go and not lose track of the entire collection of tasks being performed across any number of machines. In the even that the connection with an ECS is lost an LCS will always remember the disposition of its tasks, and dutifully report that information once a connection is re-established with an ECS.

LCS Resource Requests

All service requests made of the LCS are requested via <resource-request>messages. Resource requests can take three forms: ‘execute’, ‘kill’ and ‘complete’. See XML document below in Listing 4. The <arguments> subdocument can contain one or more XML documents. Once the new task or worker is created and executing, each of these documents is communicated to the new worker.

<resource-request>

<task-id> </task-id>
<resource-id> </resource-id>
<action> execute | kill | complete </action>
<arguments>

[xml document or documents containing task parameters]

</arguments>

</resource-request>

Listing 4

Execute Resource Request

A resource request action of ‘execute’ causes a new task to be executed. A process for the indicated resource-id is started and the document or documents contained in the <arguments> subdocument are passed to that worker as individual messages. The data passed to the new worker is passed through without modification or regard to content.

The LCS responds to the ‘execute’ request, with a notification message indicating the success or failure condition of the operation. A ‘started’ message indicates the task was successfully started. A ‘failed’ message indicates an error was encountered. The following XML document (Listing 5) is a example of a ‘started’/‘failed’ message, generated in response to a ‘execute’ request.

<notification-message>

<date-time>2001-05-03 21:50:59</date-time>
<computer-name>host</computer-name>
<user-name>J. Jones</user-name>
<task-status>

<started></started> or <failed></failed>

</task-status>
<resource-id>1</resource-id>
<task-id>42</task-id>

</notification-message>

Listing 5

If an error is encountered in the process of executing this task, the LCS will return an appropriate ‘error’ message which will also contain a potentially platform specific description of the problem. See the table below. Notification messages were briefly described above and are more fully defined in their own document. Notification messages are used to communicate task status, errors, warnings, informational messages, debugging information, etc. Aside from <resource-status> messages, all other communication to the ECS is in the form of notification messages. The table below (Listing 6) contains a description of the ‘error’ notification messages generated by the LCS in response to a ‘execute’ resource request. For an example of the dialog between an ECS and LCS see the section labeled ECS/LCS Dialogue Examples.

| | |
|---|---|
| error-messages | |
| error AME_NOTCFG | Error, Media Encoder not configured |
| error AME_UNKRES | Media Encoder unknown resource \hat{ }1) |
| error AME_RESSTRT | Error, worker failed to start (\hat{ }1, \hat{ }2) |

Listing 6

These responses would also include any notification messages generated by the actual worker itself before it failed. If during the course of normal task execution a worker terminates unexpectedly then the LCS generates the following notification message (Listing 7), followed by a ‘failed’ notification message.

| | |
|---|---|
| error-messages | |
| error AME_RESDIED | Error, worker terminated without |
| | cause (\hat{ }1, \hat{ }2). |

Listing 7

An ‘execute’ resource request causes a record to be established and maintained within the LCS, even after the worker completes or fails its task. This record is maintained until the ECS issues a ‘complete’ resource request for that task.

“Insertion strings” are used in the error messages above. An insertion string is indicated by the ‘A’ character followed by a number. These are markers for further information. For example, the description of the AME_UNKRES has an insertion string which would contain a resource-id.

Kill Resource Request

A resource request action of ‘kill’ terminates the specified task. A notification message is returned indicating that the action was performed regardless of the current state of the worker process or task. The only response for a ‘kill’ resource request is a ‘killed’ message. The example XML document (Listing 8) is an example of this response.

<notification-message>

<date-time>2001-05-03 21:50:59</date-time>
<computer-name>host</computer-name>
<user-name>J. Jones</user-name>
<task-status>

<killed></killed>

</task-status>
<resource-id>1</resource-id>
<task-id>42</task-id>

</notification-message>

Listing 8

Complete Resource Request

A resource request action of ‘complete’ is used to clear job status from the LCS. The task to be completed is indicated by the task-id. This command has no response. If a task is running when a complete arrives, that task is terminated. If the task is not running, and no status is available in the status map, no action is taken. In both cases warnings are written to the log file. See the description of the ‘execute’ resource-request for further details on task state.

ECS/LCS Dialogue Examples

As described above, the LCS provides a task independent way of exporting operating system services on a local computer system or server to a distributed system. Communication of both protocol and task specific data is performed in such a way as to be computer platform independent. This scheme is task independent in that it provides a mechanism for the creation and management of task specific worker processes using a mechanism that is not concerned with the data payloads delivered to the system workers, or the tasks they perform.

In the following example the XML on the left side of the page is the XML transmitted from the ECS to the LCS. The XML on the right side of the pages is the response made by the LCS to the ECS. The example shows the establishment of an initial connection between an ECS and LCS, and the commands and responses exchanged during the course of configuration, and the execution of a worker process. The intervening text is commentary and explanation.

### EXAMPLE 1

A TCP/IP connection to the LCS is established by the ECS. It then transmits a <1cs-configuration> message (see Listing 9).

<lcs-configuration>

<lcs-resource-id>99</lcs-resource-id>
<log-config>0</log-config>
<resource>

<id>1</id>
<name>fileman</name>
<program>fileman.exe</program>

</resource>
<resource>

<id>2</id>
<name>msencode</name>
<program>msencode.exe</program>

</resource>

</lcs-configuration>

Listing 9

The LCS responds (Listing 10) with a <resource-status> message thus verifying a configuration, and signaling that both resource 1 and 2 are both available.

<resource-status>

<status>ok</status>
<config-status>configured</config-status>
<resource-id>1</resource-id>
<resource-id>2</resource-id>

</resource-status>

Listing 10

The ECS transmits a <resource-request> message (Listing 11) requesting the execution of a resource, in this case, resource-id 1, which corresponds to the fileman (file-manager) worker. The document <doc> is the data intended input for the fileman worker.

<resource-request>

<task-id>42</task-id>
<resource-id>1</resource-id>
<action>execute</action>
<arguments>

<doc>

<test></test>

</doc>

</arguments>

</resource-request>

Listing 11

The LCS creates a worker process successfully, and responds with a started message (Listing 12). Recall from the discussion above that were this to fail one or more error messages would be generated followed by a ‘failed’ message.

```
<notification-message>
  <date-time>2001-05-03 21:33:01</date-time>
  <computer-name>host</computer-name>
  <user-name>J. Jones</user-name>
  <task-status>
    <started></started>
  </task-status>
  <resource-name>fileman</resource-name>
  <resource-id>1</resource-id>
  <task-id>42</task-id>
</notification-message>
```

Listing 12

Individual worker processes generate any number of notification-messages of their own during the execution of their assigned tasks. These include but are not limited to, basic status messages indicating the progress of the task. The XML below (Listing 13) is one of those messages.

```
<notification-message>
  <date-time>2001-05-03 21:33:01</date-time>
  <computer-name>host</computer-name>
  <user-name>J. Jones</user-name>
  <task-status>
    <pct-complete>70</pct-complete>
    <elapsed-seconds>7</elapsed-seconds>
  </task-status>
  <resource-name>fileman</resource-name>
  <resource-id>1</resource-id>
  <task-id>42</task-id>
</notification-message>
```

Listing 13

All worker processes signify the successful or unsuccessful completion of a task, with similar notification-messages. If any worker process aborts or crashes a failure is signaled by the LCS.

Upon completion of a task the LCS signals the worker process to terminate (Listing 14). If the worker process fails to self terminate within a specific timeout period the worker process is terminated by the LCS.

```
<notification-message>
  <date-time>2001-05-03 21:33:44</date-time>
  <computer-name>host</computer-name>
  <user-name>J. Jones</user-name>
  <task-status>
    <success></success>
  </task-status>
  <resource-name>fileman</resource-name>
  <resource-id>1</resource-id>
  <task-id>42</task-id>
</notification-message>
```

Listing 14

Upon completion of a task by a worker process, regardless of success or failure, the ECS will then complete that task with a <resource-request> message (Listing 15). This clears the task information from the LCS.

```
<resource-request>
  <task-id>42</task-id>
  <resource-id>1</resource-id>
  <action>complete</action>
</resource-request>
```

Listing 15

At this point the task is concluded and all task state has been cleared from the LCS. This abbreviated example shows the dialogue that takes place between the ECS and the LCS, during an initial connection, configuration and the execution of a task. It is important to note however that the LCS is in no way limited in the number of simultaneous tasks that it can execute and manage, this is typically dictated by the native operating system its resources and capabilities.

### EXAMPLE 2

This example (Listing 16) shows the interchange between the ECS and LCS, if the ECS were to make an invalid request of the LCS. In this case, an execute request with an invalid resource-id given. The example uses a resource-id of 3, and assume that the configuration from the previous example is being used. It only contains two resources, 1 and 2. Thus resource-id 3 is invalid and an incorrect request.

```
<resource-request>
  <task-id>43</task-id>
  <resource-id>3</resource-id>
  <action>execute</action>
  <arguments>
    <doc>
      <test></test>
    </doc>
  </arguments>
</resource-request>
```

Listing 16

A resource request for resource-id 3 is clearly in error. The LCS responds with an appropriate error, followed by a ‘failed’ response for this resource request (Listing 17).

```
<notification-message>
  <date-time>2001-05-04 08:55:46</date-time>
  <computer-name>host</computer-name>
  <user-name>J. Jones</user-name>
  <error>
    <msg-token>AME_UNKRES</msg-token>
    <msg-string>Media Encoder unknown resource (3) </msg-
string>
    <insertion-string>3</insertion-string>
    <source-file>lcs.cpp</source-file>
    <line-number>705</line-number>
    <compile-date>May  3 2001 21:29:08</compile-date>
  </error>
  <resource-id>3</resource-id>
  <task-id>43</task-id>
</notification-message>
<notification-message>
  <date-time>2001-05-04 08:55:46</date-time>
  <computer-name>host</computer-name>
  <user-name>J. Jones</user-name>
  <task-status>
    <failed></failed>
  </task-status>
  <resource-id>3</resource-id>
  <task-id>43</task-id>
</notification-message>
```

Listing 17

As before, the ECS will always complete a task with a ‘complete’ resource request (Listing 18). Thus clearing all of the state for this task from the LCS.

```
<resource-request>
  <task-id>43</task-id>
  <resource-id>3</resource-id>
  <action>complete</action>
</resource-request>
```

Listing 18

Message Handling

The following describes the message handling system of the preferred embodiment. It includes definition and discussion of the XML document type used to define the message catalog, and the specification for transmitting notification messages from a worker. It discusses building the database that contains all of the messages, descriptions, and (for errors) mitigation strategies for reporting to the user.

Message catalog:

Contains the message string for every error, warning, and information message in the system.

Every message is uniquely identified using a symbolic name (token) of up to 16 characters.

Contains detailed description and (for errors and warnings) mitigation strategies for each message.

Stored as XML, managed using an XML-aware editor (or could be stored in a database).

May contain foreign language versions of the messages.

Notification Messages:

Used to transmit the following types of information from a worker: errors, warnings, informational, task status, and debug.

A single XML document type is used to hold all notification messages.

The XML specification provides elements to handle each specific type of message.

Each error/warning/info is referenced using the symbolic name (token) that was defined in the message catalog. Insertion strings are used to put dynamic information into the message.

Workers must all follow the defined messaging model. Upon beginning execution of the command, the worker sends a task status message indicating “started working”. During execution, the worker may send any number of messages of various types. Upon completion, the worker must send a final task status message indicating either “finished successfully” or “failed”. If the final job status is “failed”, the worker is expected to have sent at least one message of type “error” during its execution.

The Message Catalog

All error, warning, and informational messages are defined in a message catalog that contains the mapping of tokens (symbolic name) to message, description, and resolution strings. Each worker will provide its own portion of the message catalog, stored as XML in a file identified by the .msgcat extension. Although the messages are static, insertion strings can be used to provide dynamic content at run-time. The collection of all .msgcat files forms the database of all the messages in the system.

The XML document for the message catalog definition is defined in Listing 19:

```
DTD:
<!ELEMENT msg-catalog (msg-catalog-section*)>
<!ELEMENT msg-catalog-section (msg-record+)>
<!ELEMENT msg-record (msg-token, msg-string+, description+,
resolution*)>
<!ELEMENT msg-token (#PCDATA)>
<!ELEMENT msg-string (#PCDATA)>
<!ATTLIST msg-string language (English|French|German) “English”>
<!ELEMENT description (#PCDATA)>
<!ATTLIST description language (English|French|German) “English”>
<!ELEMENT resolution (#PCDATA)>
<!ATTLIST resolution language (English|French|German) “English”>
<msg-catalog-section>
  <msg-record>
    <msg-token></msg-token>
    <msg-string language=“English”></msg-string>
    <msg-string language=“French”></msg-string>
    <msg-string language=“German”></msg-string>
    ...
    <description language=“English”></description>
    <description language=“French”></description>
    <description language=“German”></description>
    ...
    <resolution language=“English”></resolution>
    <resolution language=“French”></resolution>
    <resolution language=“German”></resolution>
    ...
  </msg-record>
  ...
</msg-catalog-section>
```

Listing 19

msg-catalog-section

XML document containing one or more <msg-record> elements.

msg-record

Definition for one message. Must contain exactly one <msg-token>, one or more <msg-string>, one or more <description>, and zero or more <resolution> elements.

msg-token

The symbolic name for the message. Tokens contain only numbers, upper case letters, and underscores and can be up to 16 characters long. All tokens must begin with a two-letter abbreviation (indicating the worker) followed by an underscore. Every token in the full message database must be unique.

msg-string

The message associated with the token. The “language” attribute is used to specify the language of the message (English is assumed if the “language” attribute is not specified). When the message is printed at run-time, insertion strings will be placed wherever a “#” (caret followed by a number) appears in the message string. The first insertion-string will be inserted everywhere “\hat{ }1” appears in the message string, the second everywhere “\hat{ }2” appears, etc. Only 9 insertion strings (1-9) are allowed for a message.

Description

Detailed description of the message and its likely cause(s). Must be provided for all messages.

Resolution

Suggested mitigation strategies. Typically provided only for errors and warnings.

An example file defining notification messages specific to the file manager is shown in Listing 20:

<msg-catalog-section>

| <!-- **************************************************** | | * --> |
|---|---|---|
| <!-- * | FILE MANAGER SECTION | * --> |
| <!-- * | | * --> |

| | |
|---|---|
| <!-- * These messages are specific to the File Manager. | * --> |
| <!-- * All of the tokens here begin with “FM_”. | * --> |
| <!-- **************************************************** | * --> |

```
  <msg-record>
    <msg-token>FM_CMDINVL</msg-token>
    <msg-string>Not a valid command</msg-string>
    <description>This is returned if the FileManager gets a command that it does
not understand.</description>
    <resolution>Likely causes are that the FileManager executable is out of
date, or there was a general system protocol error. Validate that the install on
the machine is up to date.</resolution>
  </msg-record>
  <msg-record>
    <msg-token>FM_CRDIR</msg-token>
    <msg-string>Error creating subdirectory ‘\hat{ }1’</msg-string>
  <description>The FileManager, when it is doing FTP transfers will create
directories on the remote machine if it needs to and has the privilege. This error
is generated if it is unable to create a needed directory.</description>
    <resolution>Check the remote file system. Probably causes are insufficient
privilege, full file system, or there is a file with the same name in the way of
the directory creation.</resolution>
  </msg-record>
  <msg-record>
    <msg-token>FM_NOFIL</msg-token>
    <msg-string> No file(s) found matching ‘\hat{ }1’</msg-string>
    <description>If the filemanager was requested to perform an operation on a
collection of files using a wildcard operation and this wild card evaluation
results in NO files being found. This error will be generated.</description>
    <resolution>Check your wild carded expression.</resolution>
  </msg-record>
  <msg-record>
    <msg-token>FM_OPNFIL</msg-token>
    <msg-string> Error opening file ‘\hat{ }1’, \hat{ }2</msg-string>
    <description>Filemanager encountered a problem opening a file. It displays
the name as well as the error message offered by the operating
system. </description>
    <resolution>Check the file to make sure it exists and has appropriate
permissions. Take your cue from the system error in the message.</resolution>
  </msg-record>
  <msg-record>
    <msg-token>FM_RDFIL</msg-token>
    <msg-string> Error reading file ‘\hat{ }1’, \hat{ }2</msg-string>
    <description>Filemanager encountered a problem reading a file. It displays
the name as well as the error message offered by the operating
system.</description>
    <resolution>Check the file to make sure it exists and has appropriate
permissions. Take your cue from the system error in the message.</resolution>
  </msg-record>
  <msg-record>
    <msg-token>FM_WRFIL</msg-token>
    <msg-string>Error writing file ‘\hat{ }1’, \hat{ }2</msg-string>
    <description>Filemanager encountered a problem writing a file. It displays
the name as well as the error message offered by the operating
system.</description>
    <resolution>Check to see if the file system is full. Take your cue from the
system error in the message.</resolution>
  </msg-record>
  <msg-record>
    <msg-token>FM_CLSFIL</msg-token>
    <msg-string> Error closing file ‘\hat{ }1’, \hat{ }2</msg-string>
    <description>Filemanager encountered a problem closing a file. It displays
the name as well as the error message offered by the operating
system.</description>
    <resolution>Check to see if the file system is full. Take your cue from the
system error in the message.</resolution>
  </msg-record>
  <msg-record>
    <msg-token>FM_REMOTE</msg-token>
    <msg-string> Error opening remote file ‘\hat{ }1’, \hat{ }2</msg-string>
    <description>Encountered for ftp puts. The offending file name is listed,
the system error is very confusing. It is the last 3 to 4 lines of the FTP
protocol operation. Somewhere in there is likely a clue as to the problem. Most
probably causes are: the remote file system is full; there is a permission problem
on the remote machine and a file can't be created in that location.</description>
    <resolution>Check the remote file system. Probably causes are insufficient
privilege, full file system, or there is a file with the same name in the way of
the directory creation.</resolution>
  </msg-record>
  <msg-record>
    <msg-token>FM_GET</msg-token>
    <msg-string> Error in ftp get request, src is ‘\hat{ }1’, dest is ‘\hat{ }2’</msg-
string>
    <description>This error can be generated by a failed ftp get request.
Basically, it means there was either a problem opening and reading the source
file, or opening and writing the local file. No better information is
available.</description>
    <resolution>Check both file paths, names etc. Possible causes are bad or
missing files, full file systems, insufficient privileges.</resolution>
  </msg-record>
```

Listing 20

Similar XML message description files will be generated for all of the workers in the system. The full message catalog will be the concatenation of all of the worker .msgcat files.

Notification Messages

There are 5 message types defined for our system:

Error

Warning

Information

Task Status

Debug

All error, warning, and information messages must be defined in the message catalog, as all are designed to convey important information to an operator. Errors are used to indicate fatal problems during execution, while warnings are used for problems that aren't necessarily fatal. Unlike errors and warnings that report negative conditions, informational messages are meant to provide positive feedback from a running system. Debug and task status messages are not included in the message catalog. Debug messages are meant only for low-level troubleshooting, and are not presented to the operator as informational messages are. Task status messages indicate that a task started, finished successfully, failed, or has successfully completed some fraction of its work.

The XML document for a notification message is defined in Listing 21:

| <notification-message> | |
|---|---|
| <date-time></date-time> | |
| <computer-name></computer-name> | |
| <user-name></user-name> | |
| <resource-name></resource-name> | |
| <resource-id></resource-id> | |
| <task-id></task-id> | |
| plus one of the following child elements: | |
| <error> | |
| <msg-token></msg-token> | |
| <msg-string></msg-string> | |
| <insertion-string></insertion-string> (zero or more) | |
| <source-file></source-file> | |
| <line-number></line-number> | |
| <compile-date></compile-date> | |
| </error> | |
| <warning> | |
| <msg-token></msg-token> | |
| <msg-string></msg-string> | |
| <insertion-string></insertion-string> (zero or more) | |
| <source-file></source-file> | |
| <line-number></line-number> | |
| <compile-date></compile-date> | |
| </warning> | |
| <info> | |
| <msg-token></msg-token> | |
| <msg-string></msg-string> | |
| <insertion-string></insertion-string> (zero or more) | |
| <source-file></source-file> | |
| <line-number></line-number> | |
| <compile-date></compile-date> | |
| </info> | |
| <debug> | |
| <msg-string></msg-string> | |
| <source-file></source-file> | |
| <line-number></line-number> | |
| <compile-date></compile-date> | |
| </debug> | |
| <task-status> | |
| <started/> | or |
| <success/> | or |
| <failed/> | or |
| <killed/> | or |

```
    <pct-complete></pct-complete>
    <elapsed-seconds></elapsed-seconds>
  </task-status>
</notification-message>
```

Listing 21

date-time

When the event that generated the message occurred, reported as a string of the form YYYY-MM-DD HH:MM:SS.

computer-name

The name of the computer where the program that generated the message was running.

user-name

The user name under which the program that generated the message was logged in.

resource-name

The name of the resource that generated the message.

resource-id

The id number of the resource that generated the message.

task-id

The id number of the task that generated the message.

error

Indicates that the type of message is an error, and contains the sub-elements describing the error.

warning

Indicates that the type of message is a warning (contains the same sub-elements as <error>).

Info

Indicates that the type of message is informational (contains the same sub-elements as <error> and <warning>).

Debug

Indicates that this is a debug message.

task-status

Indicates that this is a task status message.

msg-token (error, warning, and info only)

The symbolic name for the error/warning/info message. Tokens and their corresponding message strings are defined in the message catalog.

msg-string

The English message text associated with the token, with any insertion strings already placed into the message. This message is used for logging purposes when the message database is not available to look up the message string.

insertion-string

A string containing text to be inserted into the message, wherever a “\hat{ }#” appears in the message string. There can be up to 9 instances of <insertion-string> in the error/warning/info element; the first insertion-string will be inserted wherever “1” appears in the message string stored in the database, the second wherever “\hat{ }₂” appears, etc.

source-file

The name of the source file that generated the message. C++ workers will use the pre-defined_FILE_macro to set this.

line-number

The line number in the source file where the message was generated. C++ workers will use the pre-defined_LINE_macro to set this.

compile-date

The date that the source file was compiled. C++ workers will use the pre-defined _DATE_and _TIME_macros.

Started (task-status only)

If present, indicates that the task was started

Success (task-status only)

If present, indicates that the task finished successfully. Must be the last message sent from the worker.

Failed (task-status only)

If present, indicates that the task failed. Typically at least one <error> message will have been sent before this message is sent. Must be the last message sent from the worker.

Killed (task-status only)

If present, indicates that the worker was killed (treated the same as a <failed> status). Must be the last message sent from the worker.

pct-complete (task-status only)

A number from 0 to 100 indicating how much of the task has been completed.

elapsed-seconds (task-status only)

The number of seconds that have elapsed since work started on the task.

Worker Messaging Interface

The worker will generate error, warning, status, info, and debug messages as necessary during processing. When the worker is about to begin work on a task, a <task-status> message with <started> must be sent to notify that the work has begun. This should always be the first message that the worker sends; it means “I received your command and am now beginning to act on it”. Once the processing has begun, the worker might generate (and post) any number of error, warning, informational, debug or task status (percent complete) messages. When the worker has finished working on a task, it must send a final <task-status> message with either <success> or <failed>. This indicates that all work on the task has been completed, and it was either accomplished successfully or something went wrong. Once this message is received, no further messages are expected from the worker.

For job monitoring purposes, all workers are requested to periodically send a <task-status> message indicating the approximate percentage of the work completed and the total elapsed (wall clock) time since the start of the task. If the total amount of work is not known, then the percent complete field can be left out or reported as zero. It is not necessary to send <task-status> messages more often than every few seconds.

Building the Message Database

The following discussion explains how to add local messages to the database containing all of the messages, and how to get them into the NT (or other appropriate) Event Log correctly.

Building a Worker Message Catalog

This section explains how to build the message catalog for workers.

1. Build a message catalog file containing all of the error/warning/info messages that the worker generates (see section 2 above for the XML format to follow). The file name should contain the name of the worker and the .msgcat extension, and it should be located in the same source directory as the worker code. For example, Anyworker.msgcat is located in Blue/apps/anyworker. The .msgcat file should be checked in to the CVS repository.

2. So that message tokens from different workers do not overlap, each worker must begin their tokens with a unique two- or three-letter prefix. For example, all of the Anyworker message tokens begin with “AW_”. Prefix definitions can be found in Blue/common/messages/worker_prefixes.txt—make sure that the prefix chosen for the worker is not already taken by another worker.

3. Once the worker .msgcat file is defined, it is necessary to generate a .h file containing the definition of all of the messages. This is accomplished automatically by a utility program. The Makefile for the worker should be modified to add 2 lines like the following (use the name of the worker in question in place of “Anyworker”):

Anyworker_msgcat.h: Anyworker.msgcat

$ (BUILD_MSGCAT_H) $@ $**

It is also advisable to add this .h file to the “clean” target in the Makefile:

clean:

−$(RM) Anyworker_msgcat.h $(RMFLAGS)

4. The .h file contains the definition for a MESSAGE_CATALOG array, and constant character strings for each message token. The MESSAGE_CATALOG is sent to the Notify::catalogo function upon worker initialization. The constants should be used for the msg-token parameter in calls to Notify::error( ), Notify::waming( ), and Notify::info( ). Using these constants (rather than explicitly specifying a string) allows the compiler to make sure that the given token is spelled correctly.

5. After creating the .msgcat file, it should be added to the master message catalog file. An ENTITY definition should be added at the top of the file containing the relative path name to the worker .msgcat file. Then, further in the file, the entity should be included with &entity-name. This step adds the messages to the master message catalog that is used to generate the run-time message database and the printed documentation.

Using the Notify Interface

This section explains how to send notification messages from a worker. These functions encapsulate the worker messaging interface described in section 4 above. To use them, the appropriate header file should be included in any source file that includes a call to any of the functions.

When the worker begins work on a task, it must call

Notify::startedo; to send a task-started message. At the same time, the worker should also initialize the local message catalog by calling

Notify::catalog(MESSAGE_CATALOG);

During execution, the worker should report intermediate status every few seconds by calling

Notify::status (pct_complete);

where pct_complete is an integer between 0 and 100. If the percent complete cannot be calculated (if the total amount of work is unknown), Notify::status( ) should still be called every few seconds because it will cause a message to be sent with the elapsed time. In this case, it should set the percent complete to zero.

If an error or warning is encountered during execution, use

Notify: :error (IDPARAMS, token, insertion_strings);
Notify: :warning (IDPARAMS, token, insertion_strings);

Where token is one of the character constants from the msgcat.h file, and insertion strings are the insertion strings for the message (each insertion string is passed as a separate function parameter). The worker may send multiple error and warning messages for the same task.

IDPARAMS is a macro which is defined in the notification header file, Notify.h. The IDPARAMS macro is used to provide the source file, line number, and compile date to the messaging system.

Informational messages are used to report events that a system operator would be interested in, but that are not errors or warnings. In general, the ECS and LCS are more likely to send these types of messages than any of the workers. If the worker does generate some information that a system operator should see, the form to use is

Notify::info (IDPARAMS, token, insertion_strings);

Debug information can be sent using

Notify::debug (IDPARAMS, debug_level, message_string);

The debug function takes a debug_level parameter, which is a positive integer. The debug level is used to organize debug messages by importance: level 1 is for messages of highest importance, larger numbers indicate decreasing importance. This allows the person performing debugging to apply a cut-off and only see messages below a certain level. Any verbose or frequently sent messages that could adversely affect performance should be assigned a level of 5 or larger, so that they can be ignored if necessary.

When the worker has finished executing a task, it must call either

Notify::finished (Notify::SUCCESS); or

Notify::finished (Notify::FAILED);

This sends a final status message and indicates that the worker will not be sending any more messages. If the status is FAILED, then the worker is expected to have sent at least one error message during execution of the task.

Using the XDNotifMessage Class

For most workers, the interface defined in Notify.h will be sufficient for all messaging needs. Other programs (like the LCS and ECS) will need more detailed access to read and write notification messages. For these programs, the XDNotifMessage class has been created to make it easy to access the fields of a notification message.

The XDNotifMessage class always uses some existing XmlDocument object, and does not contain any data members other than a pointer to the XmlDocument. The XDNotifMessage class provides a convenient interface to reach down into the XmlDocument and manipulate <notification-message> XML documents.

Video Processing

Regarding the video processing aspects of the invention, FIG. 8 is a block diagram showing the one possible selection of components for practicing the present invention. This includes a camera 810 or other source of video to be processed, an optional video format decoder 820, video processing apparatus 830, which may be a dedicated, accelerated DSP apparatus or a general purpose processor (with one or a plurality of CPUs) programmed to perform video processing operations, and one or more streaming encoders 841, 842, 843, etc., whose output is forwarded to servers of other systems 850 for distribution over the Internet or other network.

FIG. 9 is a flowchart showing the order of operations employed in one embodiment of the invention.

Video source material in one of a number of acceptable formats is converted (910) to a common format for the processing (for example, YUV 4:2:2 planar). To reduce computation requirements, the image is cropped to the desired content (920) and scaled horizontally (930) (the terms “scaled”, “rescaled”, “scaling” and “rescaling” are used interchangeably herein with the terms “sized”, “resized”, “sizing” and “resizing”). The scaled fields are then examined for field-to-field correlations (940) used later to associate related fields (960). Spatial deinterlacing optionally interpolates video fields to full-size frames (940). No further processing at the input rate is required, so the data are stored (950) to a FIFO buffer.

When output frames are required, the appropriate data is accessed from the FIFO buffer. Field association may select field pairs from the buffer that have desirable correlation properties (temporal deinterlacing) (960). Alternatively, several fields may be accessed and combined to form a temporally smoothed frame (960). Vertical scaling (970) produces frames with the desired output dimensions. Spatial filtering (980) is done on this small-format, lower frame-rate data. Spatial filtering may include blurring, sharpening and/or noise reduction. Finally color corrections are applied and the data are optionally converted to RGB space (990).

This embodiment supports a wide variety of processing options. Therefore, all the operations shown, except the buffering (950), are optional. In common situations, most of these operations are enabled.

Examining this process in further detail, it is noted that the material is received as a sequence of video fields at the input field rate (typically 60 Hz). The processing creates output frames at a different rate (typically lower than the input rate). The algorithm shown in FIG. 9 exploits the fact that the desired encoded formats normally have lower spatial and temporal resolution than the input.

In this process, as noted, images will be resized (as noted above, sometimes referred to as “scaled”) and made smaller. Resizing is commonly performed through a “geometric transformation”, whereby a digital filter is applied to an image in order to resizing it. Filtering is done by convolving the image pixels with the filter function. In general these filters are two-dimensional functions.

The order of operations is constrained, insofar as vertical scaling is better performed after temporal (field-to-field) operations, rather than before. The reason is that vertical scaling changes the scan lines, and because of interlacing, the scan data from any given line is varied with data from lines two positions away. If temporal operations were performed after such scaling, the result would tend to produce undesirable smearing.

If, as is conventionally done, image resizing were to be performed with a two-dimensional filter function, vertical and horizontal resizing would be performed at the same time—in other words, the image would be resized, both horizontally and vertically, in one combined operation taking place after the temporal operations (960).

However, simple image resizing is a special case of “geometric transformations,” and such resizing may be separated into two parts: horizontal resizing and vertical resizing. Horizontal resizing can then be performed using a one-dimensional horizontal filter. Similarly, vertical resizing can also be performed with a one-dimensional vertical filter.

The advantage of separating horizontal from vertical resizing is that the horizontal and vertical resizing operations can be performed at different times. Vertical resizing is still performed (970) after temporal operations (960) for the reason given above. However, horizontal resizing may be performed much earlier (930), because the operations performed to scale a horizontal line do not implicate adjacent lines, and do not unacceptably interfere with later correlations or associations.

Computational requirements are reduced when the amount of data to be operated upon can be reduced. Cropping (920) assists in this regard. In addition, as a result of separating horizontal from vertical resizing, the horizontal scaling (930) can be performed next, resulting in a further computational efficiency for the steps that follow, up to the point where such resizing conventionally would have been performed, at step 970 or later. At least steps 940, 950 and 960 derive computational benefit from this ordering of operations. Furthermore, performing horizontal resizing prior to performing temporal operations (960) provides the additional benefit of being able to use a smaller FIFO buffer for step 950, with a consequent saving in memory usage.

Furthermore, considerable additional computational efficiency results from performing both horizontal (930) and vertical (970) scaling before applying spatial filters (980). Spatial filtering can is often computationally expensive, and considerable benefit is derived from performing those operations after the data has been reduced to the extent feasible.

The embodiment described above allows all the image processing required for high image quality in the streaming format to be done in one continuous pipeline. The algorithm reduces data bandwidth in stages (horizontal, temporal, vertical) to minimize computation requirements.

Video is successfully processed by this method from any one of several input formats and provided to any one of several streaming encoders while maintaining the image quality characteristics desired by the video producer. The method is efficient enough to allow this processing to proceed in real time on commonly available workstation platforms in a number of the commonly used processing configurations. The method incorporates enough flexibility to satisfy the image quality requirements of the video producer.

Video quality may be controlled in ways that are not available through streaming video encoders. Video quality controls are more centralized, minimizing the effort otherwise required to set up different encoders to process the same source material. Algorithmic efficiency allows the processing to proceed quickly, often in real time.

DISTRIBUTING STREAMING MEDIA

Regarding the distributing streaming media aspects of the invention, a preferred embodiment is illustrated in FIGS. 14-18, and is described in the text that follows. The present invention seeks to deliver the best that a particular device can offer given its limitations of screen size, color capability, sound capability and network connectivity. Therefore, the video and audio provided for a cell phone would be different from what a user would see on a PC over a broadband connection. The cell phone user, however, doesn't expect the same quality as they get on their office computer; rather, they expect the best the cell phone can do.

Improving the streaming experience requires detailed knowledge of the end user environment and its capabilities. That information is not easily available to central streaming servers; therefore, it is advantageous to have intelligence at a point in the network much closer to the end user. The Internet community has defined this closer point as the “edge” of the network. Usually this is within a few network hops to the user. It could be their local point-of-presence (PoP) for modem and DSL users, or the cable head end for cable modem users. For purposes of this specification and the following claims, the preferred embodiment for the “edge” utilizes a location on a network that is one connection hop from the end user. At this point, the system knows detailed information on the users' network connectivity, the types of protocols they are using, and their ultimate end devices. The present invention uses this information at the edge of the network to provide an improved live streaming experience to each individual user.

A complete Agility Edge deployment, as shown in FIG. 14 consists of:

1. An Agility Enterprise™ Encoding Platform

The Agility Enterprise encoding platform (1404) is deployed at the point of origination (1403). Although it retains all of its functionality as an enterprise-class encoding automation platform, its primary role within an Agility Edge deployment is to encode a single, high bandwidth MPEG-based Agility Transport Stream™ (ATS) (1406) and deliver it via a CDN (1408) to Agility Edge encoders (1414) located in various broadband ISPs at the edge of the network.

2. One or More Agility Edge Encoders

The Agility Edge encoders (1414) encode the ATS stream (1406) received from the Agility Enterprise platform (1404) into any number of formats and bit rates based on the policies set by the CDN or ISP (1408). This policy based encoding™ allows the CDN or ISP (1408) to match the output streams to the requirements of the end user. It also opens a wealth of opportunities to add local relevance to the content with techniques like digital watermarking, or local ad insertion based on end user demographics. Policy based encoding can be fully automated, and is even designed to respond dynamically to changing network conditions.

3. An Agility Edge Resource Manager

The Agility Edge Resource Manager (1410) is used to provision Agility Edge encoders (1414) for use, define and modify encoding and distribution profiles, and monitor edge-encoded streams.

4. An Agility Edge Control System

The Agility Edge Control System (1412) provides for command, control and communications across collections of Agility Edge encoders (1414).

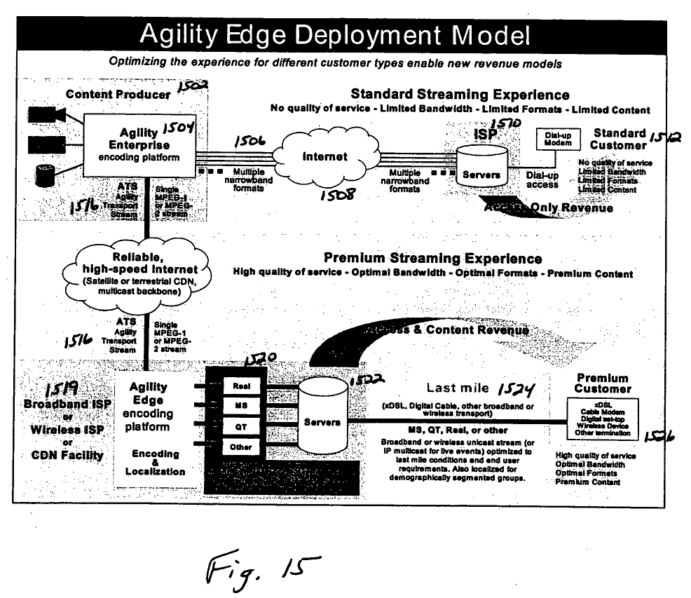

FIG. 15 shows how this fully integrated, end-to-end solution automatically provides content to everyone in the value chain.

The content producer (1502) utilizes the Agility Enterprise encoding platform (1504) to simplify the production workflow and reduce the cost of creating a variety of narrowband streams (1506). That way, customers (1512) not served by Agility Edge Encoders (1518) still get best-effort delivery, just as they do throughout the network today. But broadband and wireless customers (1526) served by Agility Edge equipped CDNs and ISPs (1519) will receive content (1524) that is matched to the specific requirements of their connection and device. Because of this, the ISP (1519) is also much better prepared to offer tiered and premium content services that would otherwise be impractical. With edge-based encoding, the consumer gets higher quality broadband and wireless content, and they get more of it.

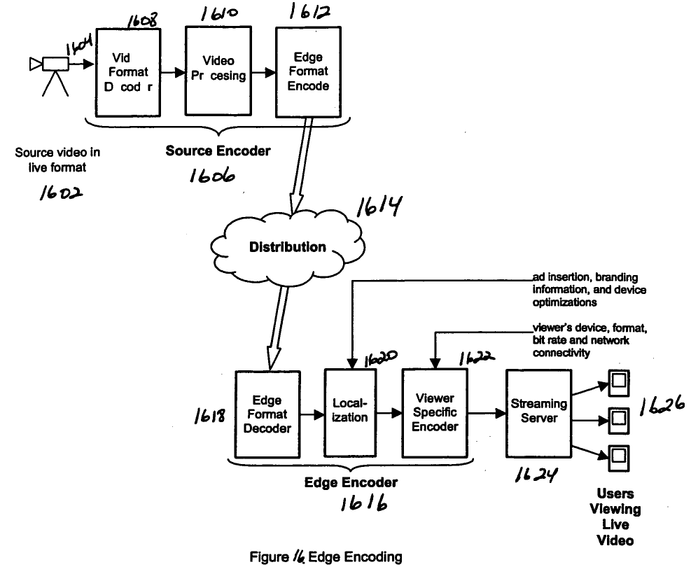

Turning to FIG. 16, which depicts an embodiment of Edge Encoding for a video stream, processing begins when the video producer (1602) generates a live video feed (1604) in a standard video format. These formats, in an appropriate order of preference, may include SDI, DV, Component (RGB or YUV), S-Video (YC), Composite in NTSC or PAL. This live feed (1604) enters the Source Encoder (1606) where the input format is decoded in the Video Format Decoder (1608). If the source input is in analog form (for example, Component, S-Video, or Composite), it will be digitized into a raw video and audio input. If it is already in a digital format (for example, SDI or DV), the specific digital format will be decoded to generate a raw video and audio input.

From here, the Source Encoder (1606) performs video and audio processing (1610). This processing may include steps for cropping, color correction, noise reduction, blurring, temporal and spatial down sampling, the addition of a source watermark or “bug”, or advertisement insertion. Additionally, filters can be applied to the audio. Most of these steps increase the quality of the video and audio. Several of these steps can decrease the overall bandwidth necessary to transmit the encoded media to the edge. They include cropping, noise reduction, blurring, temporal and spatial down sampling. The use of temporal and spatial down sampling is particularly important in lowering the overall distribution bandwidth; however, it also limits the maximum size and frame rate of the final video seen by the end user. Therefore, in the preferred embodiment, its settings are chosen based on the demands of the most stringent edge device.

The preferred embodiment should have at least a spatial down sampling step to decrease the image size and possibly temporal down sampling to lower the frame rate. For example, if the live feed is being sourced in SDI for NTSC then it has a frame size of 720×486 at 29.97 frames per second. A common high quality Internet streaming media format is at 320×240 by 15 frames a second. By using spatial and temporal down sampling to reduce the SDI input to 320×240 by 15 frames per second lowers the number of pixels (or PELs) that must be compressed to 10% of the original requirement. This would be a substantial savings to video producer and content delivery network.

Impressing a watermark or “bug” on the video stream allows the source to brand their content before it leaves their site. Inserting ads into the stream at this point is equivalent to national ad spots on cable or broadcast TV. These steps are optional, but add great value to the content producer.

Once video and audio processing is finished, the data is compressed in the Edge Format Encoder (1612) for delivery to the edge devices. While any number of compression algorithms can be used, the preferred embodiment uses MPEG1 for low bit rate streams (less than 2 megabits/second) and MPEG2 for higher bit rates. The emerging standard MPEG4 might become a good substitute as commercial versions of the codec become available. Once compressed, the data is prepared for delivery over the network (1614), for example, the Internet.

Many different strategies can be used to deliver the streaming media to the edge of the network. These range from point to point connections for limited number of Edge devices, working with third party supplies of multicast networking technologies, to contracting with a Content Delivery Network (CDN). The means of delivery, which are outside the scope of this invention, are known to those of ordinary skill in the art.

Once the data arrives at the Edge Encoder (1616), the media stream is decoded in the Edge Format Decoder (1618) from its delivery format (specified above), and then begins local customization (1620). This customization is performed using the same type of video and audio processing used at the Source Encoder (1606), but it has a different purpose. At the source, the processing was focused on preparing the media for the most general audience and for company branding and national-style ads. At the edge in the Edge Encoder (1616), the processing is focused on customizing the media for best viewing based on knowledge of local conditions and for local branding and regional or individual ad insertion. The video processing steps common at this stage may include blurring, temporal and spatial down sampling, the addition of a source watermark or “bug”, and ad insertion. It is possible that some specialized steps would be added to compensate for a particular streaming codec. The preferred embodiment should at least perform temporal and spatial down sampling to size the video appropriate for local conditions.

Once the media has been processed, it is sent to one or more streaming codecs (1622) for encoding in the format appropriate to the users and their viewing devices. In the preferred embodiment, the Viewer Specific Encoder (1622) of the Edge Encoder (1616) is located one hop (in a network sense) from the end users (1626). At this point, most of the users (1626) have the same basic network characteristics and limited viewing devices. For example, at a DSL PoP or Cable Modem plant, it is likely that all of the users have the same network speed and are using a PC to view the media. Therefore, the Edge Encoder (1616) can create just two or three live Internet encoding streams using Viewer Specific Encoders (1622) in the common PC formats (at the time of this writing, the commonly used formats include Real Networks, Microsoft and QuickTime). The results of the codecs are sent to the streaming server (1624) to be viewed by the end users (1626).

Edge encoding presents some unique possibilities. One important one is when the viewing device can only handle audio (such as a cell phone). Usually, these devices are not supported because it would increase the burden on the video producer. Using Edge Encoders, the video producer can strip out the video leaving only the audio track and then encode this for presentation to the user. In the cell phone example, the user can hear the media over the earpiece.

The present invention offers many advantages over current Internet Streaming Media solutions. Using the present invention, video producers have a simplified encoding workflow because they only have to generate and distribute a single encoded stream. This reduces the video producers' product and distribution costs since they only have to generate and distribute a single format.

While providing these cost reductions, the present invention also improves the end user's streaming experience, since the stream is matched to that particular user's device, format, bit rate and network connectivity. The end user has a more satisfying experience and is therefore more likely to watch additional content, which is often the goal of video producers.

Further, the network providers currently sell only network access, such as Internet access. They do not sell content. Because the present invention allows content to be delivered at a higher quality level than is customary using existing technologies, it becomes possible for a network provider to support premium video services. These services could be supplied to the end user for an additional cost. It is very similar to the television and cable industry that may have basic access and then multiple-tiered premium offerings. There, a basic subscriber only pays for access. When a user gets a premium offering, their additional monthly payment is used to supply revenue to the content providers of the tiered offering, and the remainder is additional revenue for the cable provider.

The present invention also generates unique opportunities to customize content based on the information the edge encoder possesses about the end user. These opportunities can be used for localized branding of content or for revenue generation by insertion of advertisements. This is an additional source of revenue for the network provider. Thus, the present invention supports new business models where the video producers, content delivery networks, and the network access providers can all make revenues not possible in the current streaming models.

Moreover, the present invention reduces the traffic across the network, lowering network congestion and making more bandwidth available for all network users.

Pre-Processing Methodology of the Present Invention

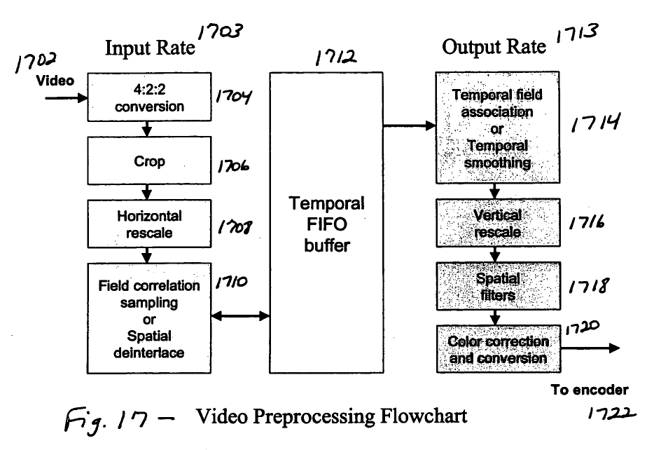

One embodiment of the invention, shown in FIG. 17, takes source video (1702) from a variety of standard formats and produces Internet streaming video using a variety of streaming media encoders. The source video (1702) does not have the optimum characteristics for presentation to the encoders (1722). This embodiment provides a conversion of video to an improved format for streaming media encoding. Further, the encoded stream maintains the very high image quality supported by the encoding format. The method in this embodiment also performs the conversion in a manner that is very efficient computationally, allowing some conversions to take place in real time.

As shown in FIG. 17, Video source material (1702) in one of a number of acceptable formats is converted to a common format for the processing (1704) (for example, YUV 4:2:2 planar). The algorithm shown in FIG. 17 exploits the fact that the desired encoded formats normally have lower spatial and temporal resolution than the input. The material is received as a sequence of video fields at the input field rate (1703) (typically 60 Hz). The processing creates output frames at a different rate (1713) (typically lower than the input rate).

The present invention supports a wide variety of processing options. Therefore, all the operations shown in FIG. 17 are optional, with the preferred embodiment using a buffer (1712). In a typical application of the preferred embodiment, most of these operations are enabled.

To reduce computation requirements, the image may be cropped (1706) to the desired content and rescaled horizontally (1708). The rescaled fields are then examined for field-to-field correlations (1710) used later to associate related fields. Spatial deinterlacing (1710) optionally interpolates video fields to full-size frames. No further processing at the input rate (1703) is required, so the data are stored to the First In First Out (FIFO) buffer (1712).

When output frames are required, the appropriate data is accessed from the FIFO buffer (1712). Field association may select field pairs (1714) from the buffer that have desirable correlation properties (temporal deinterlacing). Alternatively, several fields may be accessed and combined to form a temporally smoothed frame (1714). Vertical rescaling (1716) produces frames with the desired output dimensions. Spatial filtering (1718) is done on this small-format, lower frame-rate data. Spatial filtering (1718) may include blurring, sharpening and/or noise reduction. Finally, color corrections are applied and the data are optionally converted (1720) to RGB space.

This embodiment of the invention allows all the image processing required for optimum image quality in the streaming format to be done in one continuous pipeline. The algorithm reduces data bandwidth in stages (horizontal, temporal, vertical) to minimize computation requirements.

Content, such as video, is successfully processed by this embodiment of the invention from any one of several input formats and provided to any one of several streaming encoders while maintaining the image quality characteristics desired by the content producer. The embodiment as described is efficient enough to allow this processing to proceed in real time on commonly available workstation platforms in a number of the commonly used processing configurations. The method incorporates enough flexibility to satisfy the image quality requirements of the video producer.

Video quality may be controlled in ways that are not available through streaming video encoders. Video quality controls are more centralized, minimizing the effort otherwise required to set up different encoders to process the same source material. Algorithmic efficiency allows the processing to proceed quickly, often in real time.

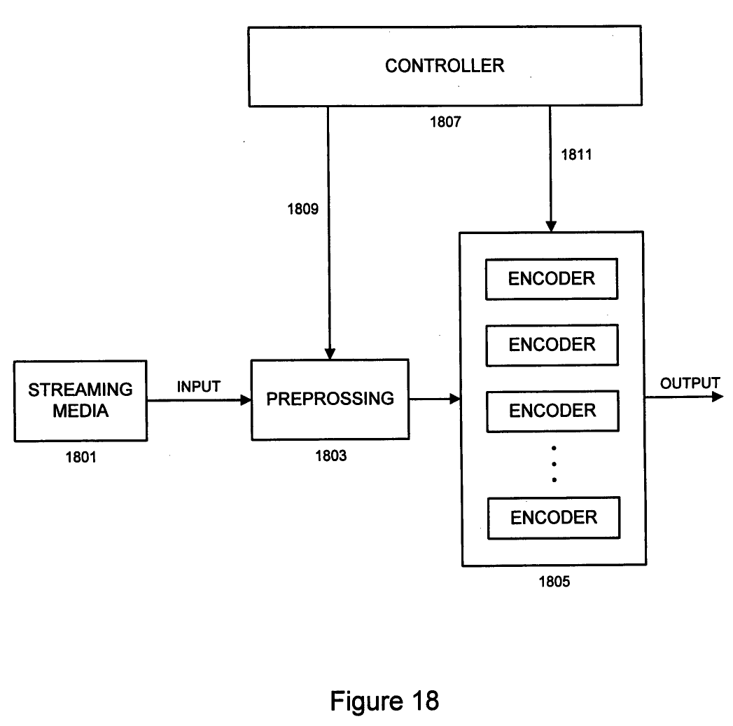

FIG. 18 shows an embodiment of the workflow aspect of the present invention, whereby the content provider processes streaming media content for purposes of distribution. In this embodiment, the content of the streaming media (1801) is input to a preprocessor (1803). A controller (1807) applies control inputs (1809) to the preprocessing step, so as to adapt the processing performed therein to desired characteristics. The preprocessed media content is then sent to one or more streaming media encoders (1805), applying control inputs (1811) from the controller (1807) to the encoding step so as to adapt the encoding performed therein to applicable requirements, and to allocate the resources of the processors in accordance with the demand for the respective one or more encoders (1805).

The Benefits of Re-Encoding vs. Transcoding

It might be tempting to infer that edge-based encoding is simply a new way of describing the process of transcoding, which has been around nearly as long as digital video itself. But the two processes are fundamentally different. Transcoding is a single-step conversion of one video format into another, and re-encoding is a two-step process that requires the digital stream to be first decoded, then re-encoded. In theory, a single step process should provide better picture quality, particularly when the source and target streams share similar characteristics. But existing streaming media is burdened by a multiplicity of stream formats, and each format is produced in a wide variety of bandwidths (speed), spatial (frame size) and temporal (frame rate) resolutions. Additionally, each of the many codecs in use throughout the industry have a unique set of characteristics that must be accommodated in the production process. The combination of these differences completely erases the theoretical advantage of transcoding, since transcoding was never designed to accommodate such a wide technical variance between source and target streams. This is why in the streaming environment, re-encoding provides format conversions of superior quality, along with a number of other important advantages that cannot be derived from the transcoding process.

Among those advantages is localization, which is the ability to add local relevance to content before it reaches end users. This includes practices like local ad-insertion or watermarking, which are driven by demographic or other profile driven information. Transcoding leaves no opportunity for adding or modifying this local content, since its singular function is to directly convert the incoming stream to a new target format. But re-encoding is a two-step process where the incoming stream is decoded into an intermediate format prior to re-encoding. Re-encoding from this intermediate format eliminates the wide variance between incoming and target streams, providing for a cleaner conversion over the full range of format, bit rate, resolution, and codec combinations that define the streaming media industry today. Re-encoding is also what provides the opportunity for localization.

The Edge encoding platform of the present invention takes full advantage of this capability by enabling the intermediate format to be pre-processed prior to re-encoding for deliver to the end user. This pre-processing step opens a wealth of opportunities to further enhance image quality and/or add local relevance to the content—an important benefit that cannot be accomplished with transcoding. It might be used, for example, to permit local branding of channels with a watermark, or enable local ad insertion based on the demographics of end users. These are processes routinely employed by television broadcasters and cable operators, and they will become increasingly necessary as broadband streaming media business models mature.

The Edge encoding platform of the present invention can extend these benefits further. Through its distributed computing, parallel processing architecture, Agility Edge brings both the flexibility and the power to accomplish these enhancements for all formats and bit-rates simultaneously, in an unattended, automatic environment, with no measurable impact on computational performance. This is not transcoding. It is true edge-based encoding, and it promises to change the way broadband and wireless streaming media is delivered to end users everywhere.

The Benefits of Edge-Based Encoding

Edge-based encoding provides significant benefits to everyone in the streaming media value chain: content producers, CDNs and other backbone bandwidth providers, ISPs and consumers.

A. Benefits for Content Producers

1. Reduces Backbone Bandwidth Transmission Costs.

The current architecture for streaming media requires content producers to produce and deliver multiple broadband streams in multiple formats and bit rates, then transmit all of them to the ISPs at the edge of the Internet. This consumes considerable bandwidth, resulting in prohibitively high, and ever increasing transmission costs. Edge-based encoding requires only one stream to traverse the backbone network regardless of the widely varying requirements of end users. The end result is an improved experience for everyone, along with dramatically lower transmission costs.

2. Significantly Reduces Production and Encoding Costs.

In the present architecture, the entire cost burden of preparing and encoding content rests with the content producer. Edge-based encoding distributes the cost of producing broadband streaming media among all stakeholders, and allows the savings and increased revenue to be shared among all parties. Production costs are lowered further, since content producers are now required to produce only one stream for broadband and wireless content delivery. Additionally, an Agility Edge deployment contains an Agility Enterprise encoding platform, which automates all aspects of the streaming media production process. With Agility Enterprise, content producers can greatly increase the efficiency of their narrowband streaming production, reducing costs even further. This combination of edge-based encoding for broadband and wireless streams, and enterprise-class encoding automation for narrowband streams, breaks the current economic model where costs rise in lock-step with increased content production and delivery.

3. Enables Nearly Limitless Tiered and Premium Content Services.

Content owners can now join with CDNs and ISPs to offer tiered content models based on premium content and differentiated qualities of service. For example, a content owner can explicitly dictate that content offered for free be encoded within a certain range of formats, bit rates, or spatial resolutions. However, they may give CDNs and broadband and wireless ISPs significant latitude to encode higher quality, revenue-generating streams, allowing both the content provider and the edge service provider to share in new revenue sources based on tiered or premium classes of service.

4. Ensures Maximum Quality for all Connections and Devices.

Content producers are rightly concerned about maintaining quality and ensuring the best viewing experience, regardless of where or how it is viewed. Since content will be encoded at the edge of the Internet, where everything is known about the end users, content may be matched to the specific requirements of those users, ensuring the highest quality of service. Choppy, uneven, and unpredictable streams associated with the mismatch between available content and end user requirements become a thing of the past.

5. Enables Business Model Experimentation.

The freedom to experiment with new broadband streaming media business models is significantly impeded in the present model, since any adjustments in volume require similar adjustments to human resources and capital expenditures. But the Agility Edge platform combined with Agility Enterprise decouples the linear relationship between volume and costs. This provides content producers unlimited flexibility to experiment with new business models, by allowing them to rapidly scale their entire production and delivery operation up or down with relative ease.

6. Content Providers and Advertisers can Reach a Substantially Larger Audience.

The present architecture for streaming media makes it prohibitively expensive to produce broadband or wireless content optimized for a widespread audience, and the broadband LCD streams currently produced are of insufficient quality to enable a viable business model. But edge-based encoding will make it possible to provide optimized streaming media content to nearly everyone with a broadband or wireless connection. Furthermore, broadband ISPs will finally be able to effectively deploy last-mile IP multicasting, which allows even more efficient mass distribution of real-time content.

B. Benefits for Content Delivery Networks (CDNs)

1. Provides New Revenue Streams.

Companies that specialize in selling broadband transmission and content delivery are interested in providing additional value-added services. The Agility Edge encoding platform integrates seamlessly with existing Internet and CDN infrastructures, enabling CDNs to efficiently offer encoding services at both ends of their transmission networks.

2. Reduces Backbone Transmission Costs.

CDNs can deploy edge-based encoding to deliver more streams at higher bit rates, while greatly reducing their backbone costs. Content producers will contract with Agility Edge-equipped CDNs to more efficiently distribute optimized streams throughout the Internet. Since edge-based encoding requires only one stream to traverse the network, CDNs can increase profit by significantly reducing their backbone costs, even after passing some of the savings back to the content producer.

C. Benefits for Broadband and Wireless ISPs

1. Enables Nearly Limitless Tiered and Premium Content Services.

Just as cable and DBS operators do with television, ISPs can now offer tiered content and business models based on premium content and differentiated qualities of service. That's because edge-based encoding empowers ISPs with the ability to package content based on their own unique technical requirements and business goals. It puts control of final distribution into the hands of the ISP, which is in the best position to know how to maximize revenue in the last-mile. And since edge-based encoding allows content providers to substantially increase the amount and quality of content provided, ISPs will now be able to offer customers with more choices than ever before. Everyone wins.

2. Maximizes Usage of Last-Mile Connections.

Last-mile bandwidth is an asset used to generate revenue, just like airline seats. Therefore, bandwidth that goes unused is a lost revenue opportunity for ISPs. The ability to offer new tiered and premium content opens a multitude of opportunities for utilizing unused bandwidth to generate incremental revenue. Furthermore, optimizing content at the edge of the Internet eliminates the need to pass-through multiple LCD streams generated by the content provider, which is done today simply to ensure an adequate viewing experience across a reasonably wide audience. Because the ISP knows the precise capabilities of their last-mile facilities, they can reduce the number of last-mile streams passed through, while creating new classes of service that optimally balance revenue opportunities in any given bandwidth environment.

3. Enables ISPs to Employ Localized IP-Multicasting Over Last-Mile Bandwidth for Live Events.

Unlike television, the Internet is a one-to-one medium. This is one of its greatest strengths. But for live events, where a large audience wishes to view the same content at the same time, this one-to-one model presents significant obstacles. Among the technologies developed to overcome those obstacles, IP multicasting has been developed. IP multicasting attempts to simulate the broadcast model, where one signal is sent to a wide audience, and each audience member “tunes in” to the signal if desired. Unfortunately, the nature of the Internet works against IP multicasting. Currently, streaming media must traverse the entire Internet, from the origination point where it is encoded, through the core of the Internet and ultimately across the last-mile to the end user. The Internet's core design, with multiple router hops, unpredictable latencies and packet loss, makes IP multicasting across the core of the Internet a weak foundation on which to base any kind of a viable business model. Even a stable, premium, multicast enabled backbone is still plagued by the LCD problem. But by encoding streaming media content at the edge of the Internet, an IP multicast must only traverse the last mile, where ISPs have far greater control over the transmission path and equipment, and bandwidth is essentially free. In this homogenous environment, IP multicasting can be deployed reliably and predictably, opening up an array of new business opportunities that require only modest amounts of last-mile bandwidth.

D. Benefits for Consumers

1. Provides Improved Streaming Media Experience Across All Devices and Connections.

Consumers today are victims of the LCD experience, where rarely anyone receives content optimized for the requirements of their connection or device, if it is created for their device at all. The result is choppy, unpredictable quality that makes for an unpleasant experience. Edge-based encoding solves that problem by making it technically and economically feasible to provide everyone with the highest quality streaming media experience possible.

2. Gives Consumers a Greater Selection of Content

Edge-based encoding finally makes large-scale production and delivery of broadband and wireless content economically feasible. This will open up the floodgates of premium content, allowing consumers to enjoy a wide variety of programming that would not be available otherwise. More content will increase consumer broadband adoption, and increased broadband adoption will fuel the availability of even more content. Edge-based encoding will provide the stimulus for mainstream adoption of broadband streaming media content.

E. Benefits for Wireless Providers and Consumers

1. Provides an Optimal Streaming Media Experience Across all Wireless Devices and Connections.

Wireless devices present the biggest challenge for streaming media providers. There are many different transmission standards (TDMA, CDMA, GSM, etc.), each with low bandwidth and high latencies that vary wildly as users move within their coverage area. Additionally, there are many different device types, each with its own set of characteristics that must be taken into account such as screen size, color depth, etc. This increases the size of the encoding problem exponentially, making it impossible to encode streaming media for a wireless audience of any significant size. To do so would require encoding an impossible number of streams, each one optimized for a different service provider, different technologies, different devices, and at wildly varying bit rates. However, within any single wireless service provider's system, conditions tend to be significantly more homogeneous. With edge-based encoding the problem nearly disappears, since a service provider can optimize streaming media for the known conditions within their network, and dynamically adjust the streaming characteristics as conditions change. Edge-based encoding will finally make the delivery of streaming media content to wireless devices an economically viable proposition.

Technological Advantages of the Present Invention

The Edge encoding platform of the present invention is a true carrier-class, open architecture, software-based system, built upon a foundation of open Internet standards such as TCP/IP and XML. As with any true carrier-class solution, the present invention is massively scalable and offers mission-critical availability through a fault-tolerant, distributed architecture. It is fully programmable, customizable, and extensible using XML, enterprise-class databases and development languages such as C, C++, Java and others.

The elements of the present invention fit seamlessly within existing CDN and Internet infrastructures, as well as the existing production workflows of content producers. They are platform- and codec-independent, and integrate directly with unmodified, off-the-shelf streaming media servers, caches, and last mile infrastructures, ensuring both forward and backward compatibility with existing investments. The present invention allows content producers to achieve superior performance and video quality by interfacing seamlessly with equipment found in the most demanding broadcast quality environments, and includes support for broadcast video standards including SDI, DV, component analog, and others. Broadcast automation and control is supported through RS-422, SMPTE time code, DTMF, contact closures, GPIs and IP-triggers.

The present invention incorporates these technologies in an integrated, end-to-end enterprise- and carrier-class software solution that automates the production and delivery of streaming media from the earliest stages of production all the way to the edge of the Internet and beyond.

Conclusion

Edge-based encoding of streaming media is uniquely positioned to fulfill on the promise of ubiquitous broadband and wireless streaming media. The difficulties in producing streaming media in multiple formats and bit rates, coupled with the explosive growth of Internet-connected devices, each with varying capabilities, demands a solution to dynamically encode content closer to the end user on an as-needed basis. Edge-based encoding, when coupled with satellite- and terrestrial-based content delivery technologies, offers content owners unprecedented audience reach while providing consumers with improved streaming experiences, regardless of their device, media format or connection speed. This revolutionary new approach to content encoding finally enables all stakeholders in the streaming media value chain, content producers, CDNs, ISPs and end-user customers, to capitalize on the promise of streaming media in a way that is both productive and profitable.

It is apparent from the foregoing that the present invention achieves the specified objects, as well as the other objectives outlined herein. While the currently preferred embodiments of the invention have been described in detail, it will be apparent to those skilled in the art that the principles of the invention are readily adaptable to a wide range of other distributed processing systems, implementations, system configurations and business arrangements without departing from the scope and spirit of the invention.

We claim:

1. A system for real-time command and control of a distributed processing system, comprising:
a high-level control system;
one or more local control systems; and
one or more “worker” processes under the control of each such local control system; wherein,
a task-independent representation is used to pass commands from said high-level control system to said worker processes;
each local control system is interposed to receive the commands from said high level control system, forward the commands to the worker processes that said local control system is in charge of, and report the status of said worker processes that it is in charge of to said high-level control system; and
said worker processes are adapted to accept such commands, translate such commands to a task-specific representation, and report to the local control system in charge of said worker process the status of execution of the commands.

2. A system having a plurality of high-level control systems as described in claim 1, wherein a job description describes the processing to be performed, portions of said job description are assigned for processing by different high-level control systems, each of said high-level control systems having the ability to take over processing for any of the other of said high-level control systems that might fail, and can be configured to take over said processing automatically.

3. A method for performing video processing, comprising:
separating the steps of horizontal and vertical scaling, and
performing horizontal scaling prior to any of (a) field-to-field correlations, (b) spatial deinterlacing, (c) temporal field association or (d) temporal smoothing.

4. The method of claim 3, further comprising performing spatial filtering after both horizontal and vertical resizing.

5. A method for performing video preprocessing for purposes of streaming distribution, comprising:
separating the steps of said video processing into a first group to be performed at the input field rate, and a second group to be performed at the output field rate;
performing the steps of said first group;
buffering the output of said first group of steps in a FIFO buffer; and
performing, on data taken from said FIFO buffer, the steps of said second group of steps.

6. A system for an originating content provider to distribute streaming media content to users, comprising:
an encoding platform deployed at the point of origination, to encode a single, high bandwidth compressed transport stream and deliver said stream via a content delivery network to encoders located in facilities at the edge of the network;
one or more edge encoders, to encode said compressed stream into one or more formats and bit rates based on the policies set by said content delivery network or edge facility;
an edge resource manager, to provision said edge encoders for use, define and modify encoding and distribution profiles, and monitor edge-encoded streams; and
an edge control system, for providing command, control and 14 communications across collections of said edge encoders.

7. A method for a local network service provider to customize for its users the distribution of streaming media content originating from a remote content provider, comprising:
performing streaming media encoding for said content at said service provider's facility;
determining, through said service provider's facility, the connectivity and encoding requirements and demographic characteristics of the user; and
performing, at said service provider's facility, processing steps preparatory to said encoding, so as to customize said media content, including one or more steps from the group consisting of:
inserting local advertising,
inserting advertising targeted to the user's said demographic characteristics,
inserting branding identifiers, performing scaling to suit the user's said connectivity and encoding requirements,
selecting an encoding format to suit the user's said encoding requirements,
adjusting said encoding process in accordance with the connectivity of the user, and
encoding in accordance with a bit rate to suit the user's said encoding requirements.

8. A method for a local network service provider to participate in content-related revenue in connection with the distribution to user of streaming media content originating from a remote content provider, comprising:
performing streaming media encoding for said content at said service provider's facility;
performing, at said service provider's facility, processing steps preparatory to said encoding, comprising insertion of local advertising;
charging a fee for the insertion of said local advertising.

9. A method for a local network service provider to participate in content-related revenue in connection with the distribution to user of streaming media content originating from a remote content provider, comprising:
performing streaming media encoding for said content at said service provider's facility;
identifying a portion of said content as premium content;
charging the user an increased fee for access to said premium content.
